(19) United States
(12) Patent Application Publication
(10) Pub. No.: US 2009/0201705 A1
(43) Pub. Date: Aug. 13, 2009

(54) ENERGY CONVERTING APPARATUS, AND SEMICONDUCTOR DEVICE AND SWITCHING CONTROL METHOD USED THEREIN

(75) Inventors: Kazuhiro Murata, Osaka (JP); Naohiko Morota, Hyogo (JP); Yoshihiro Mori, Kyoto (JP)

Correspondence Address: STEPTOE & JOHNSON LLP, 1330 CONNECTICUT AVE., NW, WASHINGTON, DC, 20036, US

(73) Assignee: Panasonic Corporation, Kadoma-shi (JP)

(21) Appl. No.: 12/365,436

(22) Filed: Feb. 4, 2009

(30) Foreign Application Priority Data
Feb. 7, 2008 (JP) 2008-027105

(51) Int. Cl. H02H 7/125

(52) U.S. Cl. 363/53

(57) ABSTRACT

The present invention reliably reduces output power during an overload, due to overload protection in which an on-time of a switching element 1 is reduced or the peak value of a switching current is lowered by reducing the minimum value of the on-period of the switching element 1.

### FIELD OF THE INVENTION

The present invention relates to an energy conversion technique for converting power in a switching power supply or the like having an overload protective function.

### BACKGROUND OF THE INVENTION

Conventionally, a so-called switching power supply that is an energy converting apparatus which converts a given input voltage and outputs a stable output voltage in response to the switching operation of a switching element or the like is generally provided with a so-called overload protective function that inhibits an overcurrent from being supplied to output even during an overload caused by an abnormality or a short-circuit of a load connected to the output or the like.

Since an output voltage generally drops during an overload as described above, an output current becomes excessive even when energy supplied to an output unit is constant, often posing a disadvantage. In order to prevent an output current from becoming excessive, energy supplied to output during an overload must be reduced.

A description will now be given on several examples of conventional techniques that realize the overload protective function as described above.

First, a switching power supply according to conventional example 1 (for example, refer to Japanese Patent No. 3229825, a Japanese patent publication) is a chopper-type switching power supply provided with an overload protective function, which reduces energy supplied to the output and realizes overload protection by detecting an overloaded state from a drop in output voltage and reducing the oscillating frequency of the switching element and the peak value of a current (hereinafter referred to as a switching current) pulse flowing through the switching element.

A configuration example that briefly explains the conventional example 1 is shown in FIG. 23. In this power supply, output voltage detecting resistors 1014 and 1015 detect an output voltage VO, a comparator 1010 compares a voltage VODET proportional to the output voltage VO with a reference voltage (VREF 11) 1017, and a comparator 1009 compares an output VERR of the comparator 1010 with an output VOSC of an oscillator 1008. An output VPWM of the comparator 1009 controls the on/off of a switching element 1001 via a NAND circuit 1006 and a PNP transistor 1005. Through such an operation, during a normal operation that is not an overloaded state, PWM control is performed in which the on-time of the switching element is varied at a constant oscillating frequency to control the output voltage VO so as to be constant.

In this case, an overcurrent detecting circuit 1012 detects a switching current value using a switching current detecting resistor 1004, and when the current value exceeds a constant value, the overcurrent detecting circuit 1012 outputs a signal to a flip-flop circuit 1007 and causes the switching element 1001 to be turned off. In other words, the power supply is provided with an overcurrent protective function of the switching element 1001 which limits the peak value of a current pulse flowing through the switching element 1001 to a constant value or less.

Next, operations during an overload will be described. In this switching power supply, an increase in an output current IO causes the peak value of the switching current pulse to increase. However, due to the aforementioned overcurrent protective function of the switching current, since the peak value cannot exceed a constant value, the output voltage drops when the output current IO exceeds a certain value.

As described above, since the output voltage VO drops during an overload, the detected value of the output voltage VO, VODET, also drops. A comparator 1011 compares VODET with a reference voltage (VREF 12) 1018 and supplies an output signal to the oscillator 1008 and the overcurrent detecting circuit 1012. As a result, when the output voltage VO drops to a certain value during an overload, the oscillating frequency of the oscillator and the overcurrent protection value of the switching element 1001 are lowered. In other words, during an overload, the oscillating frequency of the switching element 1001 and the peak value of the current pulse are lowered to prevent the output current IO from excessively increasing.

In addition, a switching power supply according to conventional example 2 (for example, refer to Japanese Patent Laid-Open No. H05-130773, a Japanese patent publication) is a flyback-type power supply provided with an overload protective function, which reduces energy supplied to output and realizes the overload protective function by detecting a drop in output voltage during an overloaded state using an auxiliary winding power supply unit proportional to the output voltage and lowering the peak value of a switching current pulse.

A configuration example that briefly explains the conventional example 2 is shown in FIG. 24. In this power supply, a constant voltage control circuit 2024 and an error amplifier 2015 output a signal associated with an output voltage VO to an OR circuit 2014, whereby the on/off of a switching element 2001 is controlled by PWM control. Such an operation keeps the output voltage VO constant through PWM control during normal operations.

A primary winding 2031, a secondary winding 2032, and an auxiliary winding 2033 compose a transformer. The secondary winding 2032 outputs the output voltage VO, while the auxiliary winding 2033 having the same polarity as the secondary winding 2032 outputs an auxiliary winding voltage VB that is proportional to the output voltage VO. The auxiliary winding voltage VB is outputted from resistors 2006 and 2007 to a comparator 2013 as a value VOREF proportional to VB. In addition, a resistor 2002 functions to detect a switching current value and outputs a voltage value IOREF proportional to the switching current to the comparator 2013. When IOREF becomes greater than VOREF, the comparator 2013 operates so as to turn off the switching element 2001.

Since the output voltage VO is constant during normal operations, VOREF is also constant. Therefore, the switching current is limited to a constant value or less. Consequently, if an output current IO becomes greater than a certain value during an overload, the output voltage VO drops. At this point, since VOREF drops accordingly, the limit value of the switching current also drops. In other words, during an overload, an energy supply to the output unit is reduced by lowering the peak value of a switching current pulse to prevent the output current IO from excessively increasing.

Other very general methods include an intermittent oscillator-type overload protective function in which, while the peak value of a switching current pulse or an oscillating frequency is not varied, the oscillating period and the suspended period of the switching element are provided during an overload and the proportion of the oscillating period is decreased to reduce output power and to prevent an output current IO from excessively increasing.

A timing chart of operations during an overload in a power supply provided with an intermittent oscillator-type overload protective function is shown in FIG. 26. As shown, an intermittent operation is performed in which, after an overload occurs, oscillation is suspended when a detecting unit of some kind activates overload protection, whereafter oscillation is recommenced and suspended again at regular intervals.

Such an intermittent operation enables the supply of output power during an overload to be limited and, when a normal load state is restored, enables operations of the power supply to return to normal.

However, the overcurrent protective operation of a switching element generally includes, as elements generated in a control circuit, a minimum on-time Tonmin of a switching element which is composed of a delay time td between the detection of overcurrent and the actual turn-off of the switching element, a dead time (hereinafter referred to as a blanking time) tBLK of overcurrent detection provided to prevent an erroneous overcurrent protective operation immediately following turn-on and the like.

Since the minimum on-time Tonmin is a time during which overcurrent protection cannot be activated and the switching element is not turned off regardless of the size of the switching current, the on-time of the switching current pulse does not fall below the minimum on-time Tonmin.

In the overload protection described above, the overload protective function of the switching element lowers the peak value of the switching current pulse during an overload and prevents the output current from increasing. However, in cases where the oscillating frequency is high or the minimum on-time is long, such a minimum on-time prevents the peak value of the switching current pulse from being sufficiently lowered and the output current from being reduced.

The case where the oscillating frequency is high will now be described.

FIG. 25 is a current waveform diagram of cases where, at oscillating frequencies of 100 kHz and 200 kHz, respectively, switching current peak values have risen to an overcurrent protection detection level (a state where output power has reached maximum). Since a switching power supply is often used so as to fall in similar on-duty ranges at different frequencies, in FIG. 25, on-duty is uniformly set to 20% and on-times Ton of the switching element are respectively set to 2.0 μs (at 100 kHz) and 1.0 μs (at 200 kHz).

Now, assuming that the minimum on-time Tonmin has been set to 500 ns as shown in FIG. 25, in the case where the oscillating frequency is 100 kHz, the peak value of the switching current pulse can be lowered down to ¼ when the overcurrent protection detection level is lowered during an overload. However, in the case where the oscillating frequency is 200 kHz, the peak value of the switching current pulse can only be lowered down to ½. As described above, when the oscillating frequency is high, the oscillating period is shortened to reduce an on-time when the output power is high and reduces the difference from the minimum on-time Tonmin. Therefore, the switching current peak and the output power cannot be lowered even when the overcurrent protection detection level is lowered and, as a result, an increase in an output current IO cannot be prevented.

Furthermore, in a case where an auxiliary winding is provided and output voltage detection is performed using an auxiliary winding voltage as shown in Japanese Patent Laid-Open No. 05-130773, a Japanese patent publication, the auxiliary winding voltage is ideally a voltage that is a constant number multiple of the output voltage. However, in actuality, the auxiliary winding voltage value sometimes deviates from the ideal voltage value under the influence of a spike voltage generated in the switching voltage of the auxiliary winding. In other words, since the spike voltage varies depending on the peak value of the switching current pulse or the like, the auxiliary winding voltage specifically varies as the peak value of the switching current pulse or the output current varies even if the output voltage is constant.

As described above, when the minimum on-time Tonmin prevents the peak value of the switching current pulse from being sufficiently lowered during an overload, there are cases where the current peak value does not drop, thereby preventing the auxiliary winding voltage from dropping even when the output voltage is lowered.

In contrast, in the power supply shown in Japanese Patent Laid-Open No. 05-130773, a Japanese patent publication, since overload protection is performed in which a drop in an auxiliary winding voltage causes a drop in the peak value of a switching current pulse to reduce output power, when the auxiliary winding voltage does not drop, an output voltage cannot be reduced as described above, thereby disadvantageously preventing an overload protective function from being realized.

In addition, in a power supply which performs output voltage detection as described above using a drop in the auxiliary winding voltage and which, as shown in Japanese Patent No. 3229825, a Japanese patent publication, is further provided with two-stage overload protection where an oscillating frequency is lowered after an output voltage is lowered, the aforementioned disadvantage becomes more significant since the auxiliary winding voltage does not drop, preventing the second-stage overload protection from being activated and the output power from being sufficiently reduced.

Furthermore, as shown in Japanese Patent No. 3229825, a Japanese patent publication, while it is also possible to reduce output power during an overload by lowering the oscillating frequency, when the oscillating frequency drops to or below 20 kHz which is an audible range, the switching frequency disadvantageously causes magnetic parts such as transformers and coils to generate a noise.

In this case, while the fact that the noise can be reduced by lowering the peak value of the switching current pulse generally leads to the need for a function that lowers the peak value of the switching current pulse, even if such a function is provided, it is difficult to resolve the issue of a noise generated by magnetic parts if the peak value of the switching current pulse cannot be lowered due to the aforementioned influence of minimum on-time.

As described above, with the conventional techniques, overload protection cannot be appropriately implemented especially at a high oscillating frequency, thereby preventing a switching power supply from attaining higher frequencies and, in association therewith, preventing downsizing of magnetic parts such as transformers and coils.

In addition, in a switching power supply, as an output voltage drops, the on-duty during an operation in continuous mode generally tends to become lower. For example, in a stepdown chopper-type power supply, the on-duty during an operation in a continuous mode may be expressed as “VO/VIN” while in an ideal flyback-type power supply, the on-duty during an operation in a continuous mode may be expressed as “VO×n/(VIN+VO×n)” (where n denotes a transformer winding ratio when the on-voltage of a switching element or the forward voltage of an output rectifying diode is ignored). In any case, the on-duty during an operation in a continuous mode drops as the output voltage VO is lowered.

In the thirdly-described intermittent oscillator-type overload protection, protection is realized by reducing the proportion of the oscillating period to reduce average output power. However, due to the fact that oscillation is being suspended and that an overloaded state exists, it is conceivable that the output voltage VO will have been lowered when oscillation recommences.

As described above, since the switching power supply attempts to supply power at maximum output when the output voltage VO is low, it is conceivable that the switching element oscillates at maximum switching current under low on-duty. Although the maximum switching current is to be determined by the overcurrent protective function of the circuit controlling the switching element, at this point, the minimum on-time Tonmin addressed above becomes an issue.

The minimum on-time is a period in which overcurrent protection is not activated and the switching element cannot be turned off. When the minimum on-time Tonmin becomes longer than the on-duty in a continuous mode described above, the switching current becomes incapable of performing periodic stationary operations. FIG. 27 shows a variance in the switching current during such an oscillation recommencement. As shown, due the overcurrent protective function, the switching current can no longer be suppressed to or under a set detection level and becomes excessive. An excessive switching current sometimes destroys the switching element, thereby creating a significant disadvantage.

### DISCLOSURE OF THE INVENTION

The present invention has been made to solve the conventional disadvantages described above, and an object of the present invention is to provide an energy converting apparatus capable of, regardless of the minimum on-time of an overcurrent protective function of a switching element: sufficiently lowering the peak value of a switching current pulse to sufficiently reduce an output current; reliably preventing an increase in the output current with respect to a load; preventing a switching current from becoming excessive and thereby preventing the switching element from being destructed; and, further, realizing a noise reduction and readily achieving downsizing, lightening and cost reduction in regards to the apparatus, as well as a semiconductor device and a switching control method to be used in the energy converting apparatus.

In order to solve the disadvantages described above, an energy converting apparatus according to the present invention converts inputted energy of a certain form into energy of a specific form and outputs the converted energy, the energy converting apparatus including: an input unit to which input energy is inputted from the outside; an output unit from which output energy is outputted to the outside; a switch having an input terminal, an output terminal and a control terminal; a control circuit which is connected to the control terminal of the switch and controls the on/off of the switch; an energy transferring element to which one of the input terminal and the output terminal of the switch is connected; a rectifying/smoothing unit which is connected to the energy transferring element and transfers energy to the output unit; an output state detecting circuit which detects a state as represented by a voltage or a current of the output unit; and a load state detecting circuit which differs from the output state detecting circuit and which detects a state of a load connected to the output unit, wherein the control circuit includes: an on/off determining circuit which controls the on/off of the switch in response to the output signal of the output state detecting circuit; a circuit which determines the fixed minimum value of an on-period of the switch which is not affected by the output signal of the output state detecting circuit; and a circuit into which the output signal of the load state detecting circuit is inputted and which varies the minimum value of the on-period of the switch in response to the signal, and the energy converting apparatus is arranged so that when the load state is detected to be abnormal, the minimum value of the on-period of the switch is shortened in comparison to a case where the load state is normal.

Furthermore, the load state detecting circuit is an output voltage detecting circuit which detects the voltage value of the output unit, the control circuit includes: a circuit which determines the maximum value of energy supplied to the output unit; and a circuit into which the output signal of the output voltage detecting circuit is inputted and which judges the load state based on the voltage value of the output unit, and when the load state is detected to be abnormal due to a drop of the voltage value of the output unit to a first threshold, the minimum value of the on-period of the switch is shortened in comparison to the case where the load state is normal.

Furthermore, the circuit which determines the maximum value of energy to be supplied to the output unit includes: a circuit for detecting a current value flowing through the switch; and a circuit for determining the maximum value of a current flowing through the switch.

Furthermore, the control circuit includes a circuit which realizes a first overload protective function of reducing the energy supplied to the output unit when the voltage value of the output unit drops to a second threshold.

Furthermore, as the first overload protective function, the maximum value of the current flowing through the switch is lowered to reduce the energy supplied to the output unit.

Furthermore, as the first overload protective function, when the voltage value of the output unit is lower than the second threshold, the more the voltage value of the output unit drops, the more the maximum value of the current flowing through the switch is lowered.

Furthermore, the control circuit includes: a circuit which detects a secondary-side on-duty which is the ratio of a period of time during which a current flows through the rectifying/smoothing unit and the oscillating period of the switch; a circuit which is provided separate from the output state detecting circuit and detects the voltage value of the output unit; and a circuit which judges the load state based on the voltage value of the output unit, wherein the control circuit varies the oscillating frequency of the switch so that the secondary-side on-duty becomes constant, and when the load state is detected to be abnormal due to a drop of the voltage value of the output unit to a first threshold, the control circuit shortens the minimum value of the on-period of the switch in comparison to the case where the load state is normal.

Furthermore, as the first overload protective function, the number of switchings of the switch performed per unit time is reduced.

Furthermore, as the first overload protective function, when the voltage value of the output unit is lower than the second threshold, the more the voltage value of the output unit drops, the more the number of switchings of the switch performed per unit time is reduced.

Furthermore, as the first overload protective function, the number of switchings of the switch performed is reduced by lowering the oscillating frequency of the switch.

Furthermore, as the first overload protective function, the number of switchings of the switch performed is reduced by providing a period in which the switch is unswitchable.

Furthermore, the control circuit includes a circuit which realizes a second overload protective function which differs from the first overload protective function and reduces energy supplied to the output unit when the voltage value of the output unit drops to a third threshold that is lower than the second threshold.

Furthermore, the control circuit sets the first threshold higher than the third threshold.

Furthermore, the control circuit sets lowering of the maximum value of the current flowing through the switch as the first overload protective function and lowering of the oscillating frequency of the switch as the second overload protective function.

Furthermore, the control circuit sets the lowering of the maximum value of the current flowing through the switch as the first overload protective function and providing of a period in which the switch is unswitchable as the second overload protective function.

Furthermore, the control circuit sets the lowering of the oscillating frequency of the switch as the first overload protective function and the lowering of the maximum value of the current flowing through the switch as the second overload protective function.

Furthermore, the control circuit includes a circuit such that the more the voltage value of the output unit drops, the more the circuit reduces the minimum value of the on-period of the switch.

Furthermore, the energy transferring element is a transformer including: a first winding connected to the input unit and to the switch; a second winding connected to the rectifying/smoothing unit; and a third winding connected to the control circuit, the load state detecting circuit includes a circuit which detects the voltage value of the third winding, and the load state detecting circuit detects the voltage value of the output unit based on the detected voltage value of the third winding.

Furthermore, the load state detecting circuit is a circuit which detects a current value flowing through the switch, and the control circuit includes a circuit which detects the current value flowing through the switch and detects that the load state has become abnormal when the current value flowing through the switch reaches or exceeds a threshold to reduce the minimum value of the on-period of the switch.

Furthermore, the load state detecting circuit is a circuit which detects the oscillating frequency of the switch, and the control circuit detects that the load state has become abnormal when the oscillating frequency of the switch reaches or exceeds a threshold to reduce the minimum value of the on-period of the switch.

Furthermore, the control circuit has a function in which the on/off determining circuit varies the on-duty of the switch depending on the output signal of the output state detecting circuit, and the minimum value of the on-period of the switch is determined by the minimum value of the on-duty of the switch.

Furthermore, the control circuit includes: a circuit which detects a current value flowing through the switch; a circuit which determines the maximum value of a current flowing through the switch; a circuit which detects the current value flowing through the switch after the switch is turned on or a circuit which provides a blanking time in which the circuit for determining the maximum value of the current flowing through the switch is not activated; and a circuit which varies the blanking time, wherein the control circuit sets a portion of or all of the minimum value of an on-period of the switch as the blanking time.

Furthermore, the control circuit reduces the minimum value of the on-period of the switch by shortening the blanking time.

Furthermore, in a semiconductor device to be used in the energy converting apparatus described above, a portion of or all of the control circuit is formed on a single semiconductor substrate.

Furthermore, in a semiconductor device to be used in the energy converting apparatus described above, a portion of or all of the control circuit as well as the switch are formed on the same semiconductor substrate.

Furthermore, a switch control method according to the present invention executes, in the energy converting apparatus described above, the steps of: when controlling the on/off of the switch, determining the minimum value of the on-period of the switch; varying the minimum value of the on-period of the switch; and detecting the load state, wherein when the load state is detected to be abnormal, the minimum value of the on-period of the switch is shortened in comparison to a case where the load state is normal.

As described above, according to the present invention, in an energy converting apparatus including an overload protective function that suppresses the maximum value of a current waveform flowing through a switch during an overload, by shortening a minimum on-time in an overloaded state in comparison to a normal operation state that is not an overloaded state, the energy converting apparatus can operate normally in a normal-load state without erroneous operations, and in an overloaded state, the maximum value of a switching current can be lowered without being restricted by the minimum on-time, thereby enabling an output current to be adjusted appropriately depending on the load state.

In addition, similarly in an energy converting apparatus that lowers an oscillating frequency during an overload, since current values of a current flowing through the switch and a current flowing through a magnetic part such as a transformer can be reduced without being restricted by the minimum on-time of the switch, a noise generated by the magnetic part can be reduced.

Furthermore, in an energy converting apparatus which activates a first overload protective function which detects that an output voltage has dropped below a first threshold during an overload and lowers the maximum value of a switching current to reduce the output voltage, and which further reduces the output voltage to prevent an output current from becoming excessive by a second overload protective function which detects that an output voltage has dropped below a second threshold that is lower than the first threshold and, for example, reduces the number of switching of a switch per unit time, by reducing a minimum on-time in a state where the output voltage is higher than the second threshold, it is possible to avoid a situation where a failure of the maximum value of the switching current to drop prevents the output voltage from dropping to the second threshold and disables activation of the second overload protective function.

Moreover, by providing a function that reduces the minimum on-time when an oscillation must occur in a state of low output voltage during an overload, it is possible to prevent the switching current from becoming excessive during the minimum on-time and the switch from being destroyed.

Furthermore, by providing primary circuit components in the same single semiconductor through unification readily enabled by providing the switch and the control circuit in the same single semiconductor, the number of components making up the circuit can be reduced. Thus, when configuring a switching power supply as an energy converting apparatus, downsizing, lightening, and even cost reduction can be readily achieved.

As described above, it is now possible to realize stable operations during normal operations that are not an overloaded state and to sufficiently reduce output power in an overloaded state, and ideal overload protective characteristics can be achieved.

### BRIEF DESCRIPTION OF THE DRAWINGS

FIG. 1 is a block diagram showing a configuration example of a switching power supply that is an energy converting apparatus according to a first embodiment of the present invention;

FIG. 2 is a relationship diagram between an input signal to a semiconductor device and operational parameters in the switching power supply that is the energy converting apparatus according to the first embodiment;

FIG. 3 is a characteristic diagram showing an example of output voltage-output current characteristics in the switching power supply that is the energy converting apparatus according to the first embodiment;

FIG. 4 is a waveform diagram showing variations in a switching current during an overload in the switching power supply that is the energy converting apparatus according to the first embodiment;

FIG. 5 is a block diagram showing a configuration example of a drain current detecting circuit in the switching power supply that is the energy converting apparatus according to the first embodiment;

FIG. 6 is a block diagram showing a configuration example of a VLIMIT variable circuit in the switching power supply that is the energy converting apparatus according to the first embodiment;

FIG. 7 is a block diagram showing a configuration example of a switching power supply that is an energy converting apparatus according to a second embodiment of the present invention;

FIG. 8 is a characteristic diagram showing an example of output voltage-output current characteristics in the switching power supply that is the energy converting apparatus according to the second embodiment;

FIG. 9 is a block diagram showing a configuration example of a switching power supply that is an energy converting apparatus according to a third embodiment of the present invention;

FIG. 10 is a block diagram showing a configuration example of a switching power supply that is an energy converting apparatus according to a fourth embodiment of the present invention;

FIG. 11 is a timing chart showing operations during an overload in the switching power supply that is the energy converting apparatus according to the fourth embodiment;

FIG. 12 is a characteristic diagram showing an example of output voltage-output current characteristics in the switching power supply that is the energy converting apparatus according to the fourth embodiment;

FIG. 13 is a block diagram showing a configuration example of a switching power supply that is an energy converting apparatus according to a fifth embodiment of the present invention;

FIG. 14 is a block diagram showing a configuration example of a switching power supply that is an energy converting apparatus according to a sixth embodiment of the present invention;

FIG. 15 is a relationship diagram between an input signal to a semiconductor device and operational parameters in the switching power supply that is the energy converting apparatus according to the sixth embodiment;

FIG. 16 is a block diagram showing a configuration example of a switching power supply that is an energy converting apparatus according to a seventh embodiment of the present invention;

FIG. 17 is a relationship diagram between an input signal to a semiconductor device and operational parameters in the switching power supply that is the energy converting apparatus according to the seventh embodiment;

FIG. 18 is a characteristic diagram showing an example of output voltage-output current characteristics in the switching power supply that is the energy converting apparatus according to the seventh embodiment;

FIG. 19 is a block diagram showing a configuration example of a switching power supply that is an energy converting apparatus according to an eighth embodiment of the present invention;

FIG. 20 is a relationship diagram between an input signal to a semiconductor device and operational parameters in the switching power supply that is the energy converting apparatus according to the eighth embodiment;

FIG. 21 is a characteristic diagram showing an example of output voltage-output current characteristics in the switching power supply that is the energy converting apparatus according to the eighth embodiment;

FIG. 22 is a block diagram showing a configuration example of a case where a coil is used in a switching power supply that is an energy converting apparatus according to another embodiment of the present invention;

FIG. 23 is a block diagram showing a configuration example of a switching power supply according to Japanese Patent No. 3229825, a Japanese patent publication which is referred to herein as conventional example 1;

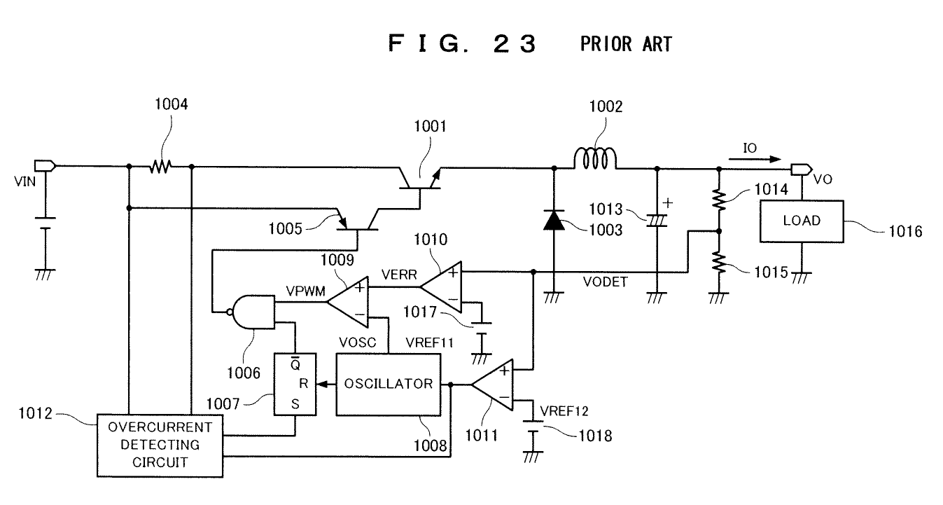

FIG. 24 is a block diagram showing a configuration example of a switching power supply according to Japanese Patent Laid-Open No. H05-130773, a Japanese patent publication which is referred to herein as conventional example 2;

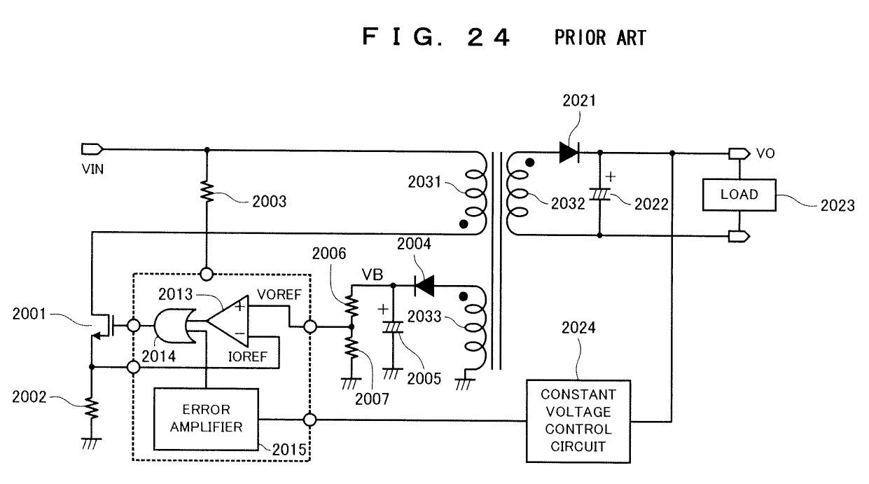

FIG. 25 is a waveform diagram showing variations in a switching current during an overload in the switching power supplies according to conventional examples 1 and 2;

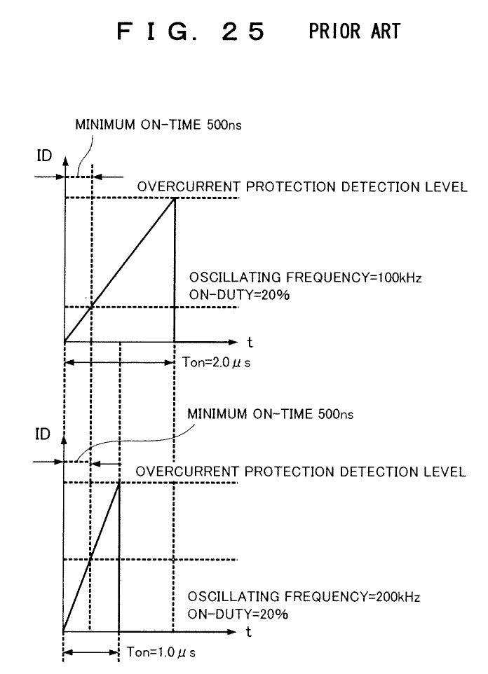

FIG. 26 is a timing chart showing operations during the overload in the switching power supplies according to conventional examples 1 and 2; and

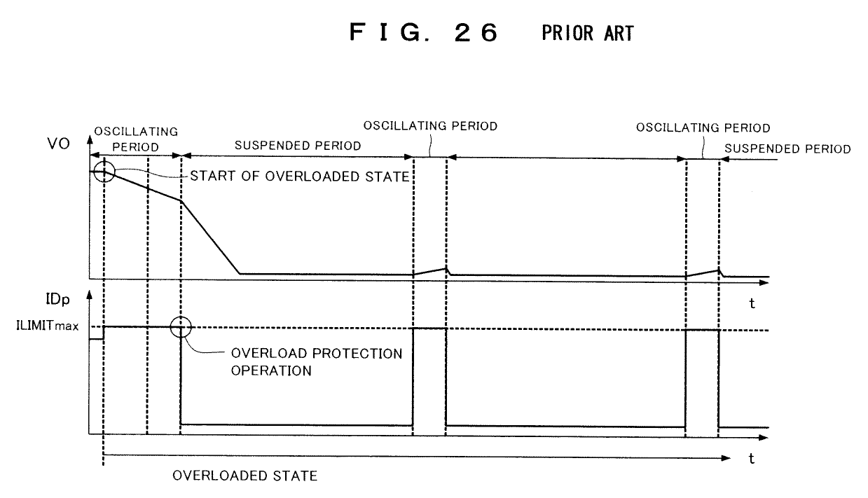

FIG. 27 is a waveform diagram showing variations in the switching current during the overload in the switching power supply according to conventional examples 1 and 2.

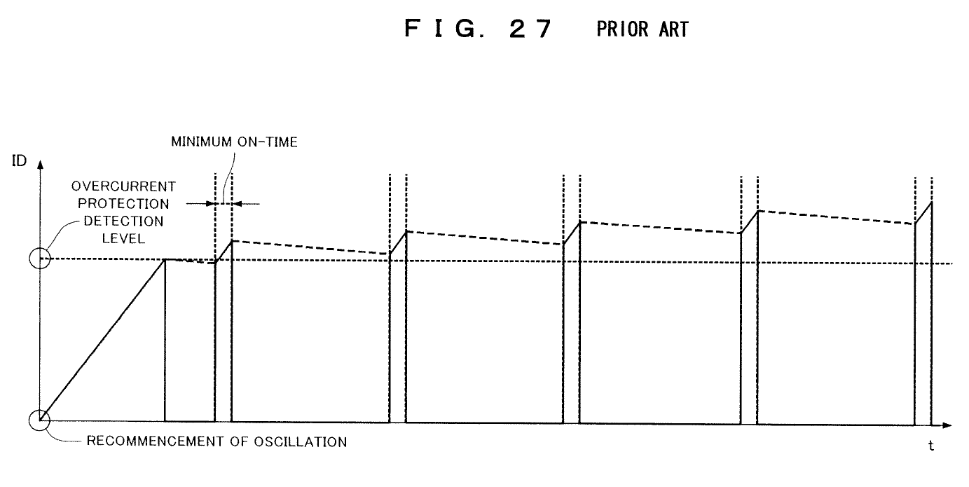

### DESCRIPTION OF THE EMBODIMENTS

An energy converting apparatus, and a semiconductor device and a switching control method used therein representing embodiments of the present invention will now be specifically described with reference to the drawings.

### First Embodiment

An energy converting apparatus, and a semiconductor device and a switching control method used therein according to a first embodiment of the present invention will now be described.

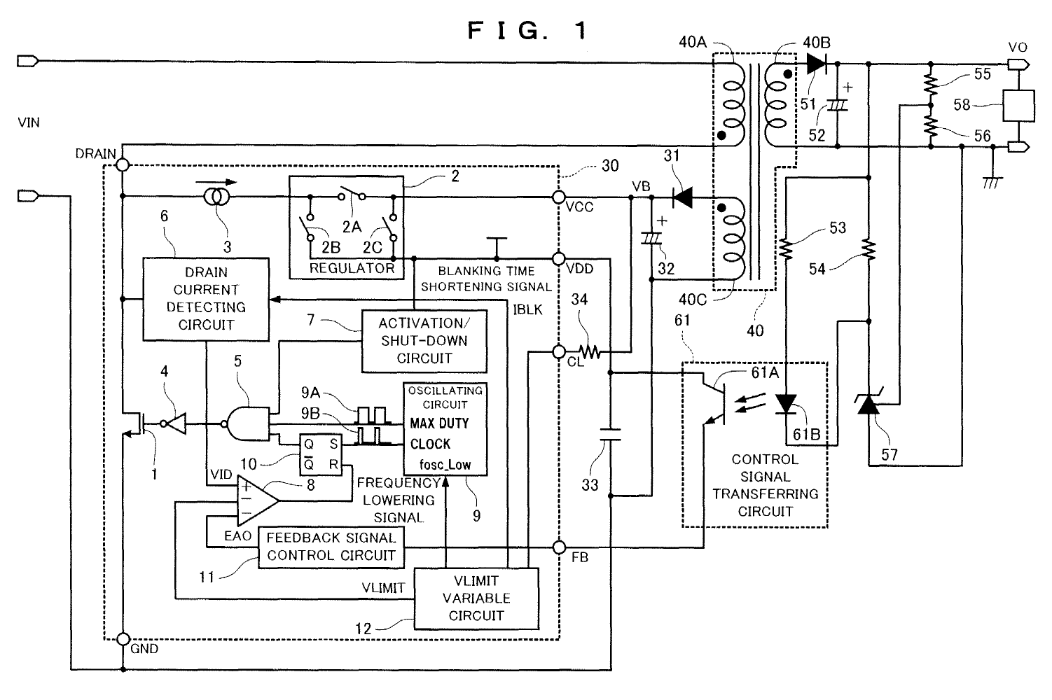

FIG. 1 is a block diagram showing a configuration example of a switching power supply that is the energy converting apparatus according to the first embodiment.

In FIG. 1, a semiconductor device 30 for controlling a switching power supply is composed of a switching element 1 as a switch and a control circuit for controlling switching operations of the switching element 1. The semiconductor device 30 includes the following six external input terminals: an input terminal of the switching element 1 (DRAIN); an auxiliary power supply voltage input terminal (VCC); an internal circuit power supply terminal (VDD); a feedback signal input terminal (FB); a current limit variable terminal (CL); an output terminal of the switching element 1 and a GND terminal of the control circuit (GND).

Reference numeral 2 denotes a regulator for supplying the internal circuit power of the semiconductor device 30, and is provided with: a switch 2A for passing a starting current to VCC; a switch 2B for passing a starting current to VDD; and a switch 2C for supplying a current from VCC to VDD.

Reference numeral 3 denotes a starting constant current source that supplies a starting circuit current and that, upon activation, supplies a starting current to VCC via the switch 2A. In addition, when VCC is equal to or below a constant voltage after activation, a circuit current is supplied to VDD via the switch 2B.

Reference numeral 7 denotes an activation/shut-down circuit for controlling the activation/shut-down of the semiconductor device 30. The activation/shut-down circuit 7 detects a voltage of VDD, and when VDD is equal to or below a constant voltage, the activation/shut-down circuit 7 outputs a signal that shuts down the switching operation of the switching element 1 to a NAND circuit 5.

Reference character 6 denotes a drain current detecting circuit for detecting a current flowing through the switching element 1 (hereinafter referred to as a drain current) and which converts a detected current into a voltage signal VID and outputs the same to a comparator 8. In addition, in order to prevent the drain current detecting circuit 6 from performing an erroneous operation and turning off immediately after the switching element 1 is turned on, the drain current detecting circuit 6 is provided with a function for generating a dead time (hereinafter referred to as a blanking time) tBLK of drain current detection.

Reference numeral 11 denotes a feedback signal control circuit that converts a current signal IFB inputted to the FB terminal into a voltage signal EAO and outputs the same to the comparator 8. A VLIMIT variable circuit 12 is a circuit that generates a signal VLIMIT for determining an overcurrent protection level ILIMIT of the drain current. Using a current value ICL applied from the CL terminal, the VLIMIT variable circuit 12 is capable of varying the level of VLIMIT and ultimately varying ILIMIT. In addition, the circuit outputs an oscillating frequency lowering signal fosc_Low to an oscillating circuit 9 and a blanking time shortening signal IBLK to the drain current detecting circuit 6. Due to this function, as ICL drops, an oscillating frequency fosc and the blanking time tBLK also drop.

The comparator 8 outputs a signal to a reset terminal (R) of an RS flipflop circuit 10 when the lower value of the output signal EAO from the feedback signal control circuit 11 and the output VLIMIT from the VLIMIT variable circuit 12 becomes equal to the output signal VID from the drain current detecting circuit 6.

Reference numeral 9 denotes an oscillating circuit which outputs a maximum duty cycle signal 9A for determining the maximum duty cycle of the switching element 1 and a clock signal 9B for determining the oscillating frequency of the switching element 1. The oscillating circuit 9 is also provided with a function that lowers the oscillating frequency when the oscillating frequency lowering signal fosc_Low is inputted from the VLIMIT variable circuit 12. The maximum duty cycle signal 9A is inputted to the NAND circuit 5 while the clock signal 9B is inputted to a set terminal (S) of the RS flipflop circuit 10.

The RS flipflop circuit 10 outputs a high-level signal to the NAND circuit 5 at a timing when an output signal CLOCK of the oscillating circuit 9 reaches a high level to determine a turn-on timing, and outputs a low-level signal to the NAND circuit 5 at a timing when the output signal of the comparator 8 drops to a low level to determine a turn-off timing.

Inputted to the NAND circuit 5 are: the output signal of the activation/shut-down circuit 7; the maximum duty cycle signal 9A; and an output signal (Q) of the RS flipflop circuit 10. The output signal of the NAND circuit 5 is inputted to a gate driver 4 and controls the switching operations of the switching element 1.

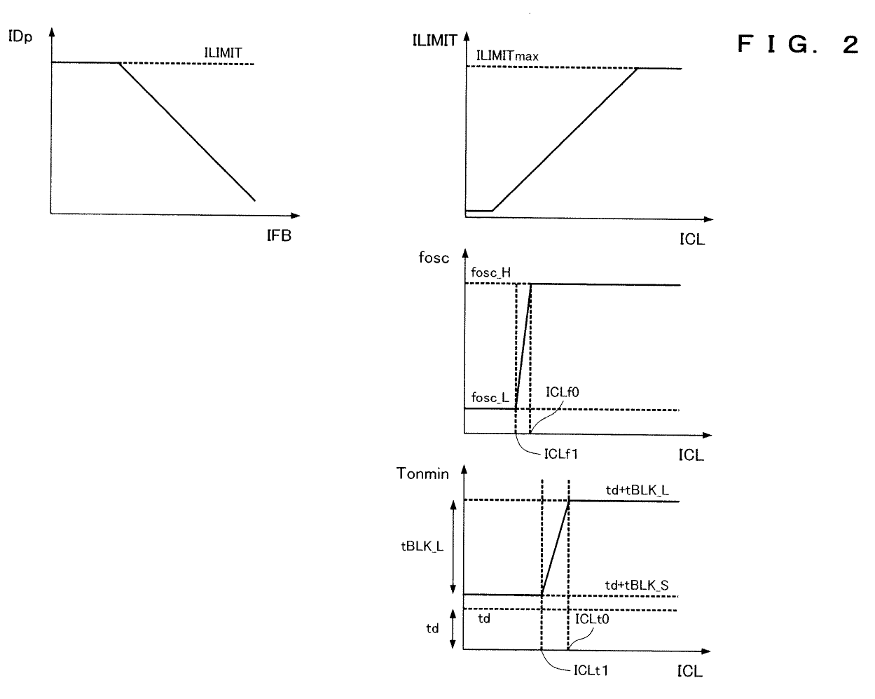

Through such a configuration, the semiconductor device 30 performs control so as to lower a maximum (peak) value IDp of a drain current pulse when an FB terminal current IFB increases and raise IDp when IFB decreases, and the semiconductor device 30 also performs control such that a maximum value ILIMIT of IDp rises when a CL terminal current ICL is large and ILIMIT drops when ICL is small. In addition, the semiconductor device 30 also performs control so as to vary the oscillating frequency fosc and the blanking time tBLK depending on ICL. FIG. 2 shows circuit characteristics thereof.

Furthermore, reference numeral 40 denotes a transformer including a primary winding 40A, a secondary winding 40B, and a primary-side auxiliary winding 40C.

Connected to the primary-side auxiliary winding 40C is a rectifying/smoothing circuit composed of a diode 31 and a capacitor 32 and which is inputted to VCC as an auxiliary power supply unit of the semiconductor device 30. Since the primary-side auxiliary winding 40C having the same polarity as the output voltage-generating secondary winding 40B generates a voltage waveform that is a constant number multiple of 40B, a voltage VB that is a constant number multiple of the output voltage is generated between both ends of the smoothing capacitor 32. The CL terminal of the semiconductor device 30 is arranged so as to be at a fixed voltage, and an auxiliary winding voltage value VB is detected as the CL terminal current ICL by a resistor 34 connected between VCC and CL.

Reference numeral 33 denotes a VDD-stabilizing capacitor. Reference numeral 61 denotes a control signal transferring circuit for transferring a control signal from the secondary side to the primary side and is composed of a phototransistor 61A and a photodiode 61B. A collector of the phototransistor 61A is connected to VDD while an emitter of the phototransistor 61A is connected to FB.

Connected to the secondary-side winding 40B is a rectifying/smoothing circuit composed of a diode 51 and a capacitor 52 and which is connected to a resistor 58. A shunt regulator 57 detects a secondary-side output voltage VO using resistors 55 and 56, and controls a current flowing through the photodiode 61B so that the output voltage VO becomes constant.

A description of operations of the switching power supply configured as described above will now be provided with reference to FIGS. 1 to 4.

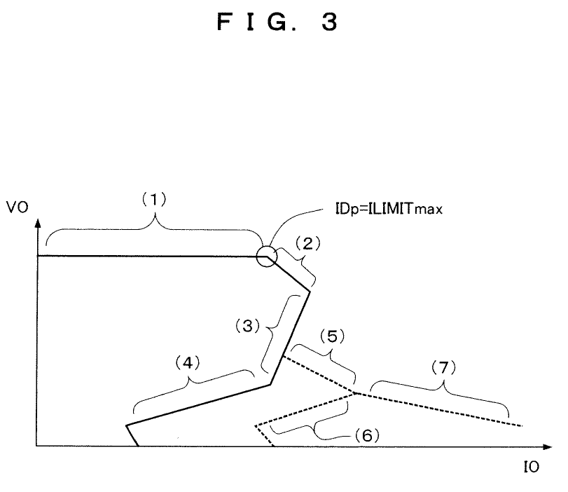

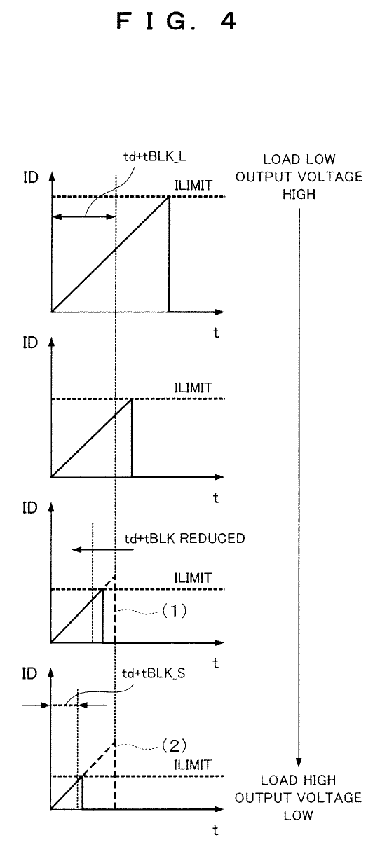

FIG. 2 is a diagram showing relationships between signals inputted to a terminal of the semiconductor device 30 shown in FIG. 1 and operational parameters of the switching element 1; FIG. 3 is a diagram showing output voltage-current characteristics obtained from the present configuration; and FIG. 4 is a diagram explaining variations in a switching current during an overload in the switching power supply.

In FIG. 1, inputted to the input terminal is, for example, a direct current voltage VIN formed by rectifying and smoothing a commercial alternating current power supply. During operations of the switching power supply, the semiconductor device 30 obtains power from the VCC terminal using, as a power supply, a voltage VCC composed of the diode 31 and the capacitor 32 of the primary-side auxiliary winding 40C. A power supply voltage of the control circuit of the semiconductor device 30 is VDD. The switch 2C in the regulator 2 causes power to be supplied from VCC so that VDD becomes a constant voltage.

The switch 2B in the regulator 2 becomes conductible during the off-time of a switching operation when the VCC voltage is equal to or below a constant value VCC (ON) such as immediately after activation or during an overload, and the switch 2B ensures that the VDD voltage does not drop by causing power to be supplied as necessary to VDD from the drain terminal even when the VCC voltage is insufficient. In addition, the switch 2B does not become conductive when the VCC voltage is equal to or greater than the constant value VCC (ON).

Furthermore, the switch 2A in the regulator 2 functions to supply power from the drain to VCC upon activation. Due to this operation, when VCC rises to a starting voltage VCC_start, the switching element 1 commences a switching operation.

A current flowing through the secondary-side winding 40B is rectified and smoothed by the diode 51 and the capacitor 52 to become a direct current, and supplies power to the resistor 58. While the output voltage VO is set by the resistors 55 and 56 and the shunt regulator 57, when a load is reduced and VO exceeds a set voltage, the shunt regulator 57 causes a current flowing through the photodiode 61B to increase and, as a result, the current IFB flowing into the FB terminal also increases.

As described above, the semiconductor device 30 has characteristics as shown in FIG. 2, and as a current flowing into the FB terminal increases, output power decreases so as to lower the drain current peak value IDp. Conversely, when a load increases and VO drops, output power increases because the current IFB flowing into the FB terminal decreases and the drain current peak value IDp rises. Such a control enables output power corresponding to a load to be supplied and the output voltage VO to be stabilized to realize constant voltage characteristics.

When an output current IO flowing through the resistor 58 is increased in such a state where the output voltage VO is stabilized, IDp increases due to the rise of the output signal EAO of the feedback signal control circuit 11 in accordance with a decrease in IFB. However, when EAO exceeds VLIMIT, IDp becomes equal to the overcurrent detection level ILIMIT, preventing IDp from rising further. When the output current IO is further increased in this state, since IDp is unable to rise and output power cannot be increased, the output power VO starts to drop.

As described above, VLIMIT that determines the overcurrent detection level ILIMIT varies in accordance with the current ICL flowing into the CL terminal as shown in FIG. 2. The value of the resistor 34 is set such that during normal operations, ILIMIT does not drop and reaches a maximum value ILIMITmax when the output voltage VO does not drop.

FIG. 3 shows output voltage-output current characteristics (hereinafter referred to as VO-IO characteristics) of the switching power supply according to the present embodiment. From a normal operating area denoted as (1) in FIG. 3, the output current IO increases and IDp rises to ILIMITmax, and ICL decreases as the output voltage VO drops, causing the auxiliary winding voltage VB (=VCC) to drop and ILIMIT to eventually start dropping. This is the description of the characteristics of an area (2) shown in FIG. 3.

Now, as described above, in the semiconductor device 30, ILIMIT, fosc, tBLK and a minimum on-time Tonmin vary with a decrease in ICL as shown in FIG. 2. The state shown in (3) of FIG. 3 is a state where a load is further increased from the state of (2) in FIG. 3 and the output voltage VO, VB, and ICL drop, causing ILIMIT to decrease.

FIG. 4 shows a variance in a drain current ID waveform at this point. After a load increases and ILIMIT starts to drop, the blanking time tBLK starts to decrease when ICL drops to ICLt0. As shown in FIG. 4, the decrease in tBLK causes a decrease in td+tBLK, enabling IDp to be lowered with a decrease in ILIMIT without being restricted by Tonmin.

In FIG. 4, the drain current waveforms represented by dotted lines (1) and (2) are drain current waveforms in a temporary case where a tBLK-reducing function has not been provided. As shown, since the peak value IDp of the drain current is determined by Tonmin even when ILIMIT drops, IDp cannot be sufficiently lowered even during an overload.

The characteristic represented by the dotted line (5) in FIG. 3 is a VO-IO characteristic when a tBLK-reducing function has not been provided and IDp cannot be sufficiently lowered. In this manner, the output current IO cannot be reduced. The characteristic represented by (6) in FIG. 3 is a characteristic in the case where, from the characteristic of (5), the output current IO is reduced due to a drop in VCC, a drop in ICL to ICLf0, and a drop in the oscillating frequency fosc. Such characteristics offer little in limiting the output current IO and cannot be described as favorable overload protection characteristics.

Next, a case represented by (7) in FIG. 3 in which overload protection characteristics further worsen will be described.

Although the auxiliary winding voltage VB (=VCC) ideally becomes a constant number multiple of the output voltage VO, there may be cases where the value of the auxiliary winding voltage VB (=VCC) deviates from the ideal voltage value due to the influence of a spike voltage generated in the switching voltage of the auxiliary winding 40C. In other words, since the spike voltage varies depending on the peak value IDp of the switching current pulse or the like, VB specifically varies as the peak value IDp of the switching current pulse or the output current IO varies even if the output voltage VO remains constant.

As described above, when the lack of a tBLK-reducing function prevents the peak value of the switching current pulse from being sufficiently lowered during an overload, the current peak value does not drop, thereby preventing the influence of the aforementioned spike voltage from being reduced. Thus, there may be cases where the auxiliary winding voltage VB does not decrease even when the output voltage is lowered. (7) in FIG. 3 represents a characteristic in the case where VB has ceased to decrease as described above. At this point, since ICL is unable to drop to ICLf0, the oscillating frequency fosc does not drop, making it totally impossible to limit the output current IO.

In contrast, the operating area represented by (4) is an area in which ICL drops to or below ICLf0 and the oscillating frequency fosc drops to reduce output power and the output current IO. As described above, since the tBLK-reducing function enables IDP to be lowered without causing any particular disadvantage and the oscillating frequency fosc to be reliably lowered without preventing VB and ICL from dropping, it is now possible to reduce the output current IO in a more reliable manner even in comparison to the VO-IO characteristics (5), (6), and (7) of the cases where the tBLK-reducing function has not been provided, represented by the dotted lines.

In this case, ICLt0 is set higher than ICLf0 in order to ensure that by reducing the blanking time prior to the oscillating frequency dropping, IDp and VB drop without incident and VB drops down to an area where the oscillating frequency drops.

Furthermore, in the present embodiment, tBLK is not varied during normal operations of the area (1) because the blanking time tBLK functions to prevent erroneous operations in regards to oscillations of the switching element and such erroneous operations are unacceptable if favorable characteristics are to be realized in this operating area. On the other hand, in the overloaded operating areas (2), (3), (4), and (5), since the overloaded states themselves are abnormal states, stable switching operations are not required and merely being able to suppress output power and the output current IO for protection shall suffice. Therefore, even in a temporary case where a reduction in the blanking time tBLK causes an erroneous operation, such an operation is oriented towards reducing output power. Since stable control is not required in such a state, such an operation does not pose a problem.

Moreover, in the present embodiment, the oscillating frequency fosc and the minimum on-time Tonmin are continuously varied in accordance with the CL terminal current ICL in order to enable a smoother return to normal operations once an overloaded state is resolved.

For the reasons stated above, the present invention that shortens the blanking time tBLK and the minimum on-time Tonmin only during an overload is therefore effective.

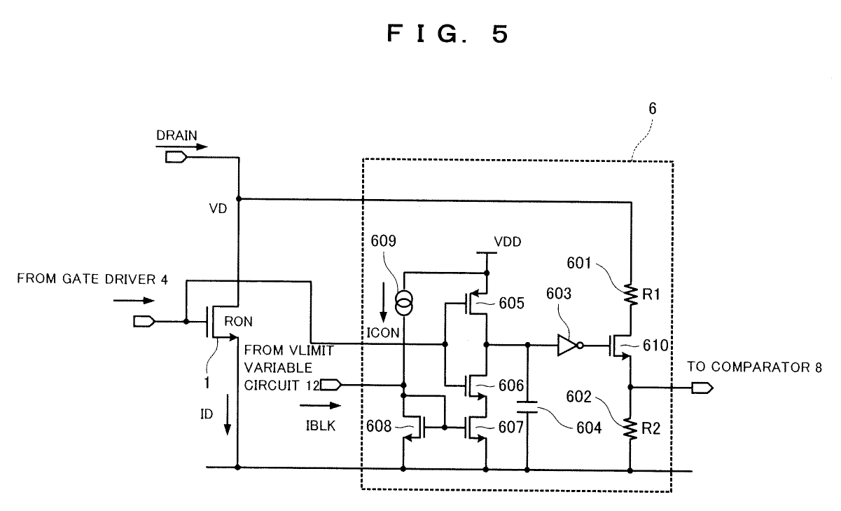

The circuit shown in FIG. 5 is a configuration example of the drain current detecting circuit 6 provided with a function for varying the blanking time tBLK. In this circuit, the drain circuit ID is detected using RON of the switching element 1, while VD that is a value proportional to ID is detected by resistors 601 and 602 and the detected value VID is outputted to the comparator 8.

Now, during a period from the point when an output of the gate driver 4 reaches a high level (hereinafter denoted by H) and the switching element 1 turns on to the point when an output of an inverter 603 reaches H, the aforementioned drain current cannot be detected since an Nch MOSFET 610 is turned off. Therefore, the blanking time is constituted by the period from the point when the output of the gate driver 4 reaches H to the point when the Nch MOSFET 610 is turned on.

When the switching element 1 is turned off, since the output of the gate driver 4 is at a low level (hereinafter denoted by L), a Pch MOSFET 605 is turned on and an Nch MOSFET 606 is turned off, an input to the inverter 603 is H. From this state, as the switching element 1 is turned on and the output of the gate driver 4 becomes H, the Pch MOSFET 605 is turned off, the Nch MOSFET 606 is turned on, a capacitance 604 commences discharge, and an input voltage of the inverter 603 starts to drop.

Ultimately, when the input to the inverter 603 drops to or below a threshold, the blanking time which is the period from the point when the Nch MOSFET 610 turns on and drain current detection becomes possible to the point when the Nch MOSFET 610 turns on is determined by a current value flowing through the capacitance 604 and the Nch MOSFET 606 and an Nch MOSFET 607. In this case, since the current capability of the Nch MOSFET 606 is set higher than the Nch MOSFET 607, the current flowing through the Nch MOSFET 606 is to be determined by the Nch MOSFET 607.

In addition, since the current value of the Nch MOSFET 607 is determined by the current value of an Nch MOSFET 608, which is, in turn, a current value obtained by adding a current ICON of a constant current source 609 and a current IBLK supplied from the VLIMIT variable circuit 12, the value of the blanking time tBLK varies depending on a value calculated as “ICON+IBLK”.

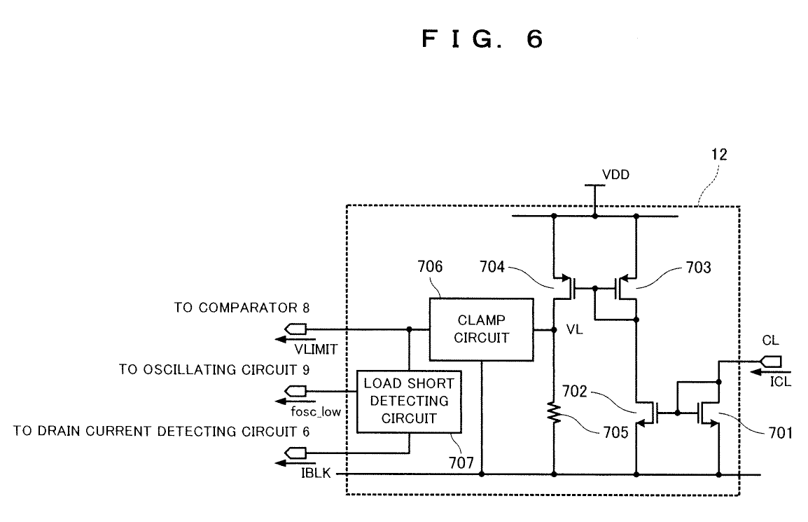

The circuit shown in FIG. 6 is a configuration example of the VLIMIT variable circuit 12. In this circuit, a current mirror circuit composed of Nch MOSFETs 701, 702 and Pch MOSFETs 703, 704 causes a current proportional to the CL terminal current ICL to flow through a resistor 705. Consequently, a collector voltage VL of the Pch MOSFET 704 varies in proportion to ICL. A clamp circuit 706 is provided with a function for clamping upper and lower limits of VL, and outputs VLIMIT that determines an overcurrent detection level ILIMIT. Due to variance in VLIMIT, ILIMIT varies as shown in FIG. 2 due to variance in ICL.

An output of the clamp circuit 706 is connected to a load short detecting circuit 707. The load short detecting circuit 707 outputs an oscillating frequency lowering signal fosc_Low to the oscillating circuit 9 and is capable of realizing characteristics as shown in FIG. 2 in which the oscillating frequency fosc is varied depending on VL.

The load short detecting circuit 707 outputs a current signal IBLK that varies the blanking time depending on VL to the drain current detecting circuit 6, and is arranged so that IBLK increases as ICL decreases. IBLK is applied to the drain current detecting circuit 6 shown in FIG. 5.

As described above, since the blanking time tBLK is determined by IBLK and ICON, tBLK varies depending on the variance of IBLK. In other words, due to the actions of the VLIMIT variable circuit 12 and the drain current detecting circuit 6, the semiconductor device 30 is capable of realizing characteristics as shown in FIG. 2 in which tBLK is shortened when ICL decreases.

### Second Embodiment

An energy converting apparatus, and a semiconductor device and a switching control method used therein according to a second embodiment of the present invention will now be described.

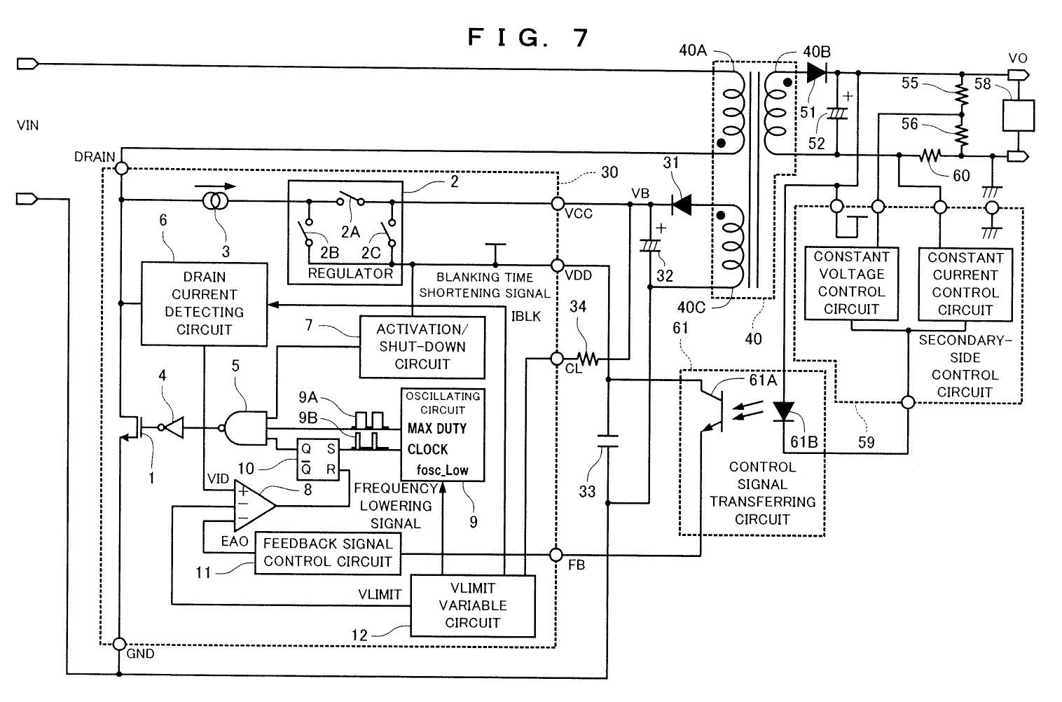

FIG. 7 is a block diagram showing a configuration example of a switching power supply that is the energy converting apparatus according to the second embodiment.

In the switching power supply, the shunt regulator 57 according to the first embodiment is replaced with a secondary-side control circuit 59 that enables constant voltage and constant current control, and an output current detecting resistor 60 is added to a portion through which an output current flows. Hereinafter, descriptions of configurations and operations similar to the first embodiment will be omitted and only portions that differ therefrom will be described.

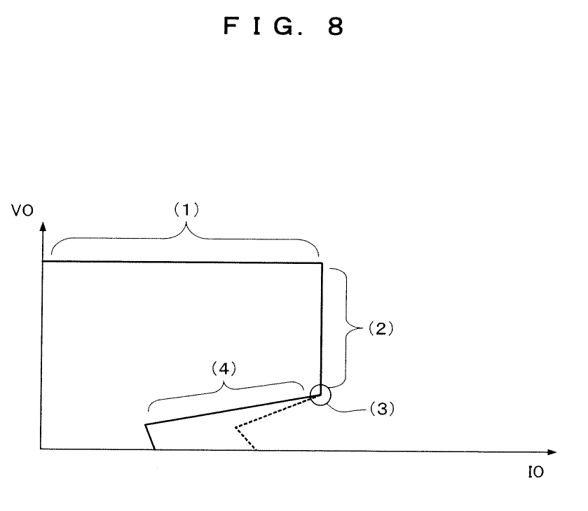

FIG. 8 shows VO-IO characteristics of a power supply according to the present embodiment. In area (1), the secondary-side control circuit 59 detects an output voltage VO using resistors 55 and 56, varies a current flowing through a photodiode 61B, a current IFB flowing through a FB terminal, and a drain current peak value IDp so that a detected value becomes virtually constant, and controls the switching of a switching element 1 so that the output voltage VO becomes constant. The requirement for performing this constant voltage control is that a potential difference between both ends of the output current detecting resistor 60 is below a constant value or, in other words, an output current IO is below a constant value.

Next, when the output current IO rises to a predetermined value, constant current control is performed as shown in area (2) of FIG. 5. More specifically, constant current control is performed by controlling the current flowing through the photodiode 61B so that the potential difference between both ends of the detecting resistor 60 becomes virtually constant.

Since the output voltage VO drops as a load is increased when performing the constant current control, an auxiliary winding voltage VB (=VCC) similarly drops. In this case, since a semiconductor device 30 has similar functions as in the first embodiment, ILIMIT starts to drop as VB and ICL drop, and eventually, an oscillating frequency fosc drops. An operating point (3) is a point where ICL=ICLf0 and the oscillating frequency fosc starts to drop. As a load further increases, the oscillating frequency fosc drops, the drop in ILIMIT causes IDp to drop as well, the output current IO is reduced as shown in area (4) of FIG. 8, and short-circuit protection is realized.

Generally, as the output voltage VO drops, a shortage in power supply voltage occurs at the secondary-side control circuit 59, disadvantageously rendering the secondary-side control circuit 59 uncontrollable. For this reason, it is required that a characteristic be realized in which the output current IO is lowered through primary-side control. In addition, as protection during a load short, it is generally required that the output current IO be suppressed to a value (for example, 30% or lower) that is smaller than IO during constant current control.

In contrast, when the semiconductor device 30 is not provided with a function of reducing tBLK in accordance with ICL, since IDp cannot be sufficiently lowered during a load short, IO cannot be sufficiently reduced. The VO-IO characteristic indicated by the dotted line in FIG. 8 represents a characteristic in the case where a tBLK-reducing function has not been provided and, as shown, IO cannot be lowered during a load short and predetermined protective characteristics cannot be acquired.

As described above, the function of reducing tBLK in accordance with ICL is also useful for a power supply provided with a control circuit for controlling constant voltage and constant current at the secondary-side in realizing favorable short-circuit protective characteristics.

### Third Embodiment

An energy converting apparatus, and a semiconductor device and a switching control method used therein according to a third embodiment of the present invention will now be described.

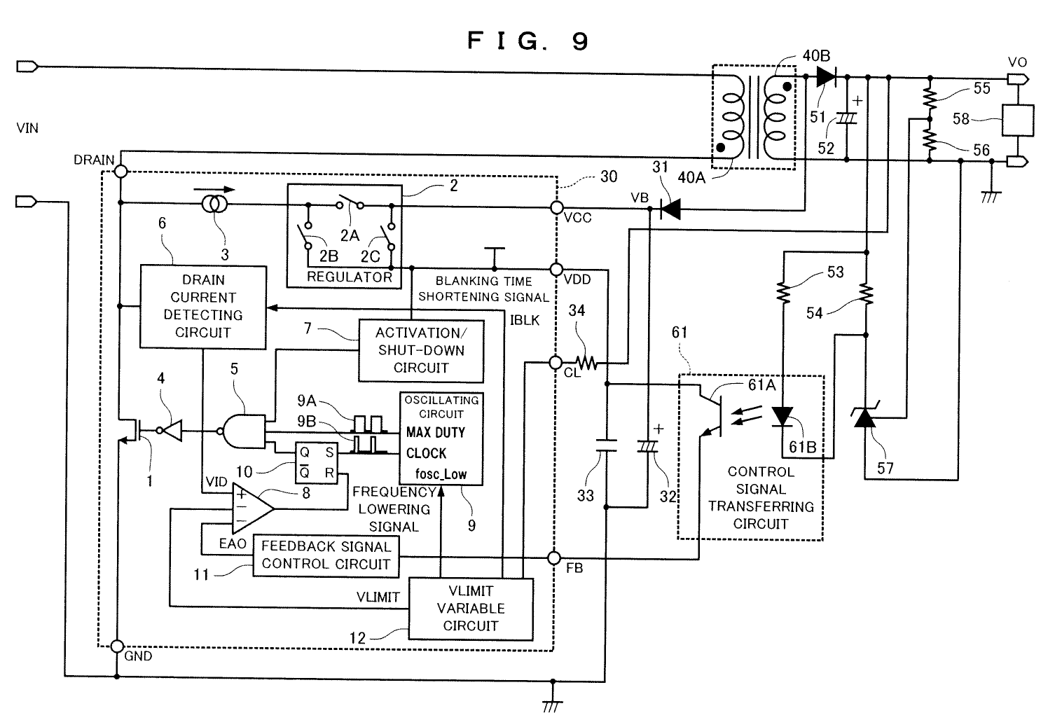

FIG. 9 is a block diagram showing a configuration example of a switching power supply that is an energy converting apparatus according to the third embodiment.

Thus far, an insulated power supply has been described on the premise of a method in which a drop of an output voltage VO is detected by a drop in a bias winding voltage VB of a primary-side auxiliary winding 40C of a transformer 40 in order to detect an overload. However, the present invention can also be applied to a non-insulated power supply that directly detects the output voltage VO and, from a drop in the output voltage VO, detects an overload.

In a switching power supply shown in FIG. 9, no insulation is provided between primary and secondary, and a resistor 34 connected to a CL terminal is directly connected to an output voltage VO. Consequently, the detection of the output voltage VO which is performed by the auxiliary winding voltage VB in the first embodiment can now be performed directly, and the same operations as the first embodiment can be performed during an overload. Other configurations are similar to the first embodiment and a description thereof will be omitted.

Even with such a configuration, the effect of reducing a minimum on-time during an overload is similar to the first embodiment.

### Fourth Embodiment

An energy converting apparatus, and a semiconductor device and a switching control method used therein according to a fourth embodiment of the present invention will now be described.

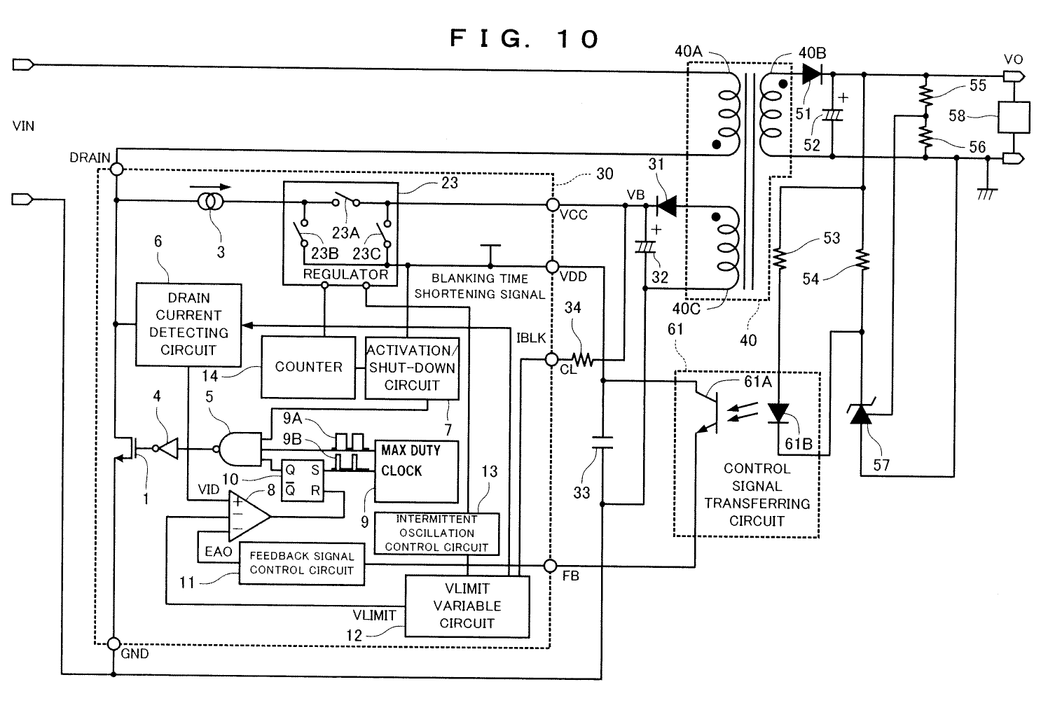

FIG. 10 is a block diagram showing a configuration example of a switching power supply that is the energy converting apparatus according to the fourth embodiment.

In a switching power supply according to the fourth embodiment, an intermittent oscillation control circuit 13 is connected to a VLIMIT variable circuit 12 and to a regulator 23. The difference from the first embodiment is that a counter 14 is provided which is connected to the regulator 23 and an activation/shut-down circuit 7.

In addition, operations of the regulator 23 also differ from the operations of the regulator 2 described earlier. The regulator 23 is provided with a function of not turning on switches 23B and 23C upon receiving a signal from the intermittent oscillation control circuit 13 and a function of controlling the switches 23B and 23C depending on a signal from the counter 14. Another difference is that the VLIMIT variable circuit 12 does not output a frequency lowering signal fosc_Low to an oscillating circuit 9 and does not lower an oscillating frequency during an overload. Otherwise, similar operations are performed.

As for characteristics of a semiconductor device 30, the relationships of ICL-ILIMIT and ICL-tBLK are the same as the characteristics of the first embodiment shown in FIG. 2, and only the ICL-fosc characteristics are changed.

When ICL drops to ICLf0 shown in FIG. 2, the VLIMIT variable circuit 12 outputs an intermittent oscillation actuation signal to the intermittent oscillation control circuit 13. The intermittent oscillation control circuit 13 to which the intermittent oscillation actuation signal has been inputted sends the signal to the regulator 23, turns off the switches 23B and 23C, and suspends current supply from drain and VCC. The counter 14 is capable of counting in the range of 0 to 3 and counts the number of times VDD drops to VDD (OFF). In addition, the counter is set to 0 prior to operations of the power supply, and outputs an enable signal to the activation/shut-down circuit 7 when the counter is 0 and outputs a disable signal to the same when the counter is 1 to 3.

The activation/shut-down circuit 7 suspends the oscillation of a switching element 1 when VDD drops to VDD (OFF), and the activation/shut-down circuit 7 starts the oscillation of the switching element 1 when VDD rises to VDD (ON) only if the output of the counter 14 is enable. When VDD drops to VDD (OFF), the regulator 23 turns on the switch 23B if VCC<VCC (ON), and the regulator 23 turns on the switch 23C and performs charging of VDD from the drain or VCC if VCC<VCC (ON).

Subsequently, the regulator 23 cuts the charge from the drain or VCC when VDD rises to VDD (ON) if the output of the counter 14 is disable, and the regulator 23 performs charging from the drain or VCC so that VDD becomes a constant value if the output of the counter 14 is enable.

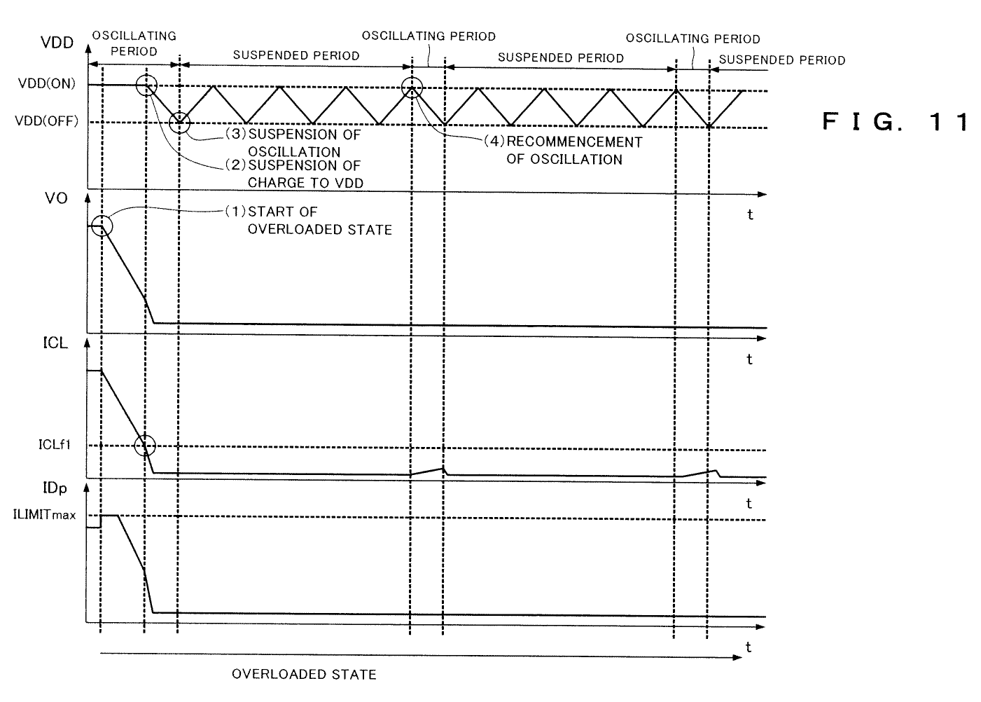

FIG. 11 shows a timing chart of operations during an overload of the power supply. As an overloaded state represented by (1) in FIG. 11 commences, VO, VB, and ICL begin to drop. The drop in ICL lowers ILIMIT, which in turn lowers IDp. Eventually, as ICL drops to ICLf1, the supply of a current from the drain terminal to VDD ceases and VDD begins to drop (the point denoted by (2) in FIG. 11). Furthermore, when VDD drops to VDD (OFF) at point (3), the oscillation of the switching element 1 is suspended due to the function described above, while the supply of a current from the drain to VDD commences. Since the count of the counter 14 at this point is 1, when VDD subsequently rises to VDD (ON), the oscillation of the switching element 1 is not recommenced, and because charging of VDD is suspended, VDD drops once again.

After repeating such operations, the oscillation of the switching element is recommenced when the count of the counter 14 once again becomes 0 (the point denoted by (4) in FIG. 11). However, in the case where the overloaded state is not resolved, charging of VDD is not recommenced since ICL is small and VDD drops again to stop the oscillation.

In other words, with the present power supply, by reducing the oscillating period during an overload, power supplied to output is reduced to realize overload protection. In addition, once the overloaded state is resolved, a rise in VCC within the oscillating period causes ICL to increase and charging to VDD recommences, thereby enabling normal operations to be performed again.

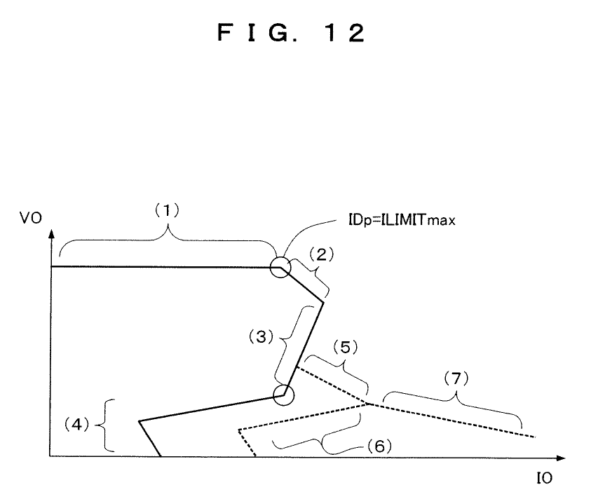

VO-IO characteristics of this circuit are shown in FIG. 12. As shown, in operating areas (1), (2), and (3), since operations similar to the first embodiment are performed, similar characteristics are realized. During an overload, when the output voltage VO, VCC, and ICL drop, an intermittent oscillation is triggered and an output current IO can be reduced as shown in the operating area (4).

In contrast, in the case where the function of reducing a blanking time tBLK has not been provided, overload protective characteristics are realized in which either an inability to lower IDp results in an inability to sufficiently reduce the output current IO even during an intermittent oscillation as indicated by the dotted line in FIG. 12 (characteristic (6)), or an inability to reduce VB results in an inability of ICL to drop to ICLf1, thereby preventing an intermittent oscillation and increasing the output current IO (characteristic (7)).

Therefore, in the case where the function of reducing a blanking time tBLK has been provided, since IDp can be lowered without being limited by a minimum on-time, it is possible to prevent the aforementioned characteristic (6) or (7) as shown in FIG. 12 from being realized. Thus, with the present embodiment, the same effects as the first embodiment can be achieved.

### Fifth Embodiment

An energy converting apparatus, and a semiconductor device and a switching control method used therein according to a fifth embodiment of the present invention will now be described.

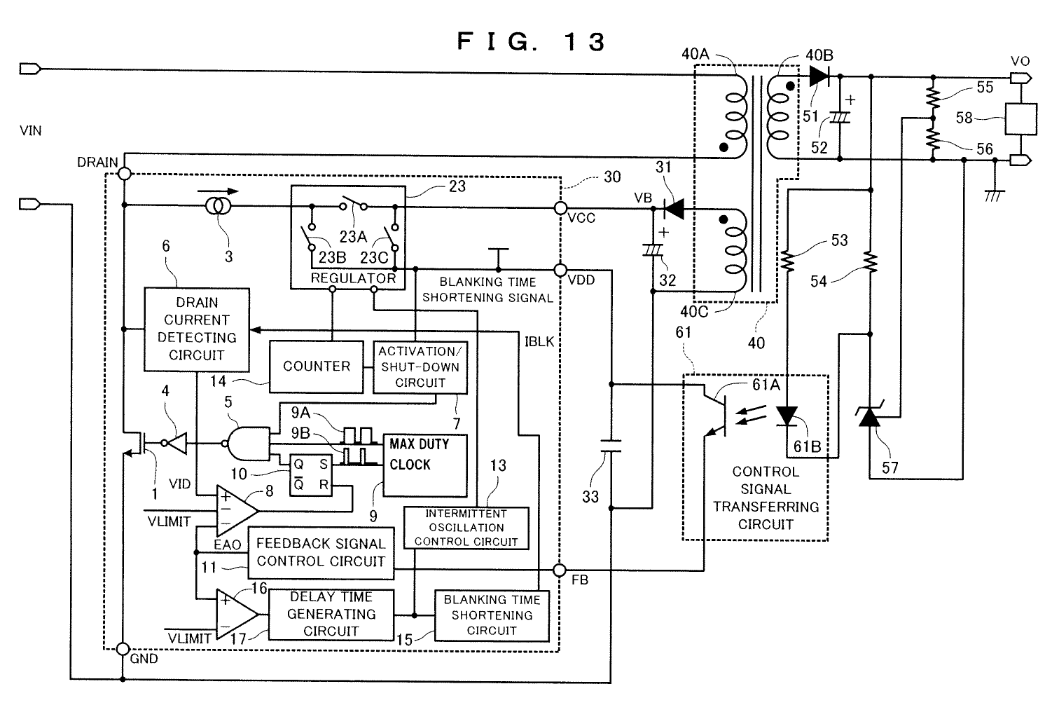

FIG. 13 is a block diagram showing a configuration example of a switching power supply that is the energy converting apparatus according to the fifth embodiment.

The block diagram of the switching power supply shown in FIG. 13 represents a configuration example of the fifth embodiment which realizes overload protection by performing an intermittent oscillation during an overload without varying IDp or an oscillating frequency fosc. The power supply is not provided with a VLIMIT variable circuit that varies VLIMIT and ILIMIT, and VLIMIT takes a constant value. In addition, the power supply includes a comparator 16 that compares an output EAO of a feedback signal control circuit 11 with VLIMIT. When EAO>VLIMIT, the comparator 16 outputs a high level signal (hereinafter referred to as an H signal) to a delay time generating circuit 17.

Upon receiving an H signal, after a predetermined delay time, the delay time generating circuit 17 outputs an H signal to a blanking time shortening circuit 15 and an intermittent oscillation control circuit 13. The delay time generating circuit 17 does not output an H signal if an input signal returns from a high level signal to a low level signal (hereinafter referred to as an L signal) within the predetermined delay time.

Upon receiving the H signal, the blanking time shortening circuit 15 outputs a blanking time shortening signal IBLK to a drain current detecting circuit 6, and as a result, a blanking time tBLK is reduced. Meanwhile, upon receiving the H signal, the intermittent oscillation control circuit 13 outputs a signal to a regulator 23, suspends current supply from a drain and VCC to VDD, and starts an intermittent oscillation operation in the same manner as the fourth embodiment. Since other portions are similar to the fourth embodiment, a description thereof will be omitted.

Now, as the power supply enters an overloaded state, an output voltage VO drops, an FE terminal current IFB increases, and EAO increases such that EAO>VLIMIT. At this point, after the lapse of a predetermined delay time determined by the delay time generating circuit 17, an H signal is inputted to the blanking time shortening circuit 15 and the intermittent oscillation control circuit 13, and overload protection is activated which involves reducing the blanking time tBLK and performing an intermittent oscillation.

With overload protection by an intermittent oscillation in which a switching current peak is prevented from dropping, as described above, the switching current disadvantageously becomes excessive during a minimum on-time and causes a switching element to be destroyed. However, with the present embodiment, by reducing the minimum on-time Tonmin during an overload, it is now possible to prevent or suppress the current from becoming excessive.

### Sixth Embodiment

An energy converting apparatus, and a semiconductor device and a switching control method used therein according to a sixth embodiment of the present invention will now be described.

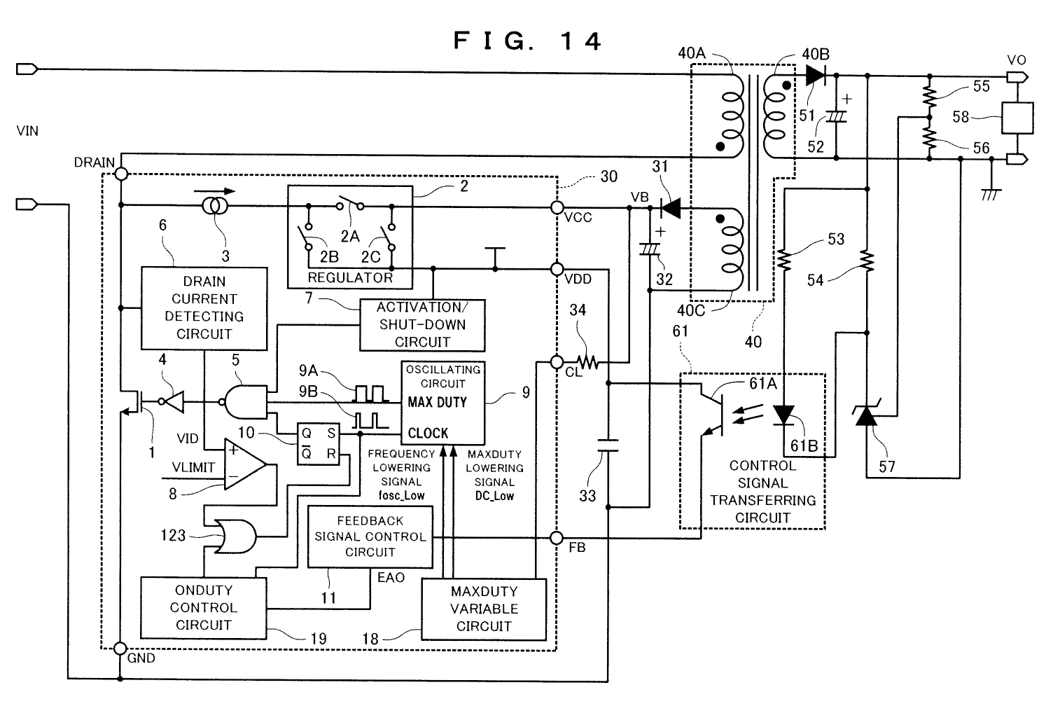

FIG. 14 is a block diagram showing a configuration example of a switching power supply that is the energy converting apparatus according to the sixth embodiment.

The switching power supply shown in FIG. 14 is a power supply circuit that controls the on-duty of a switching element 1 during normal operations that are not an overloaded state, and realizes overload protection during an overload by lowering MAXDUTY that is the maximum value of the duty and by lowering an oscillating frequency fosc.

An ONDUTY control circuit 19 is provided with a function of receiving an output EAO of a feedback signal control circuit 11 which is a value obtained by converting an FB terminal current into a voltage signal and a CLOCK signal that is an output of an oscillating circuit 9, and varying on-duty depending on EAO. More specifically, the ONDUTY control circuit 19 determines a turn-off timing by changing a signal to be outputted to an OR circuit 123 from an L signal to an H signal. The ONDUTY control circuit 19 is also provided with a function of lowering ONDUTY down only to a minimum duty MINDUTY.

A comparator 8 compares VID that is a detected value of a current flowing through the switching element 1 and VLIMIT, and when VID exceeds VLIMIT, the comparator 8 outputs an H signal to the OR circuit 123 to turn off the switching element 1. When one of the output of the comparator 8 and the output of the ONDUTY control circuit 19 becomes an H signal, the OR circuit 123 outputs a reset signal to a flipflop circuit 10 and turns off the switching element 1.

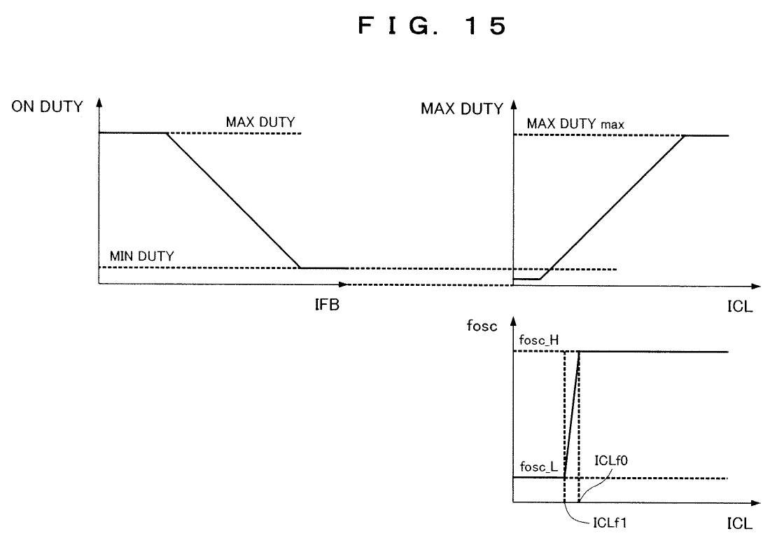

In other words, a switching current maximum value ILIMIT is set by VLIMIT, and when IDp is equal to or below ILIMIT, the on-duty of the switching element 1 is controlled by the ONDUTY control circuit 19. A MAXDUTY variable circuit 18 receives an input of a CL terminal current ICL, and, depending on ICL, outputs an oscillating frequency lowering signal fosc_Low and a MAXDUTY lowering signal DC_Low to an oscillating circuit 9. The relationships between ICL, MAXDUTY, and fosc are as shown in FIG. 15. Since other portions are similar to the first embodiment, a description thereof will be omitted.

Next, operations of the switching power supply will be described.

During normal operations that are not an overloaded state, the variance in the on-duty of the switching element 1 depending on IFB causes an output voltage to be controlled constant regardless of the load state. During an overload, the rise of the drain current peak value IDp to ILIMIT limits power supply to output, thereby causing an output voltage to start dropping.

In response thereto, a drop in auxiliary winding voltage VB (=VCC) causes the CL terminal current ICL to drop, whereby MAXDUTY starts to drop due to ICL-MAXDUTY characteristics shown in FIG. 15, and the on-duty of the switching element 1 eventually begins to decrease. Since output power starts to drop as a result, a drop in an output voltage VO is accelerated and an increase in an output current IO is suppressed.

As the output voltage VO and VB further drop and ICL drops to ICLf0, the oscillating frequency fosc drops, further suppressing output power and the output current IO. A yet further drop in ICL causes MAXDUTY to drop to or below MINDUTY and the switching element 1 to oscillate at on-duty equal to or below MINDUTY.

With PWM control of voltage modes which involves controlling on-duty as described above, it is typical to set such a minimum value (in this case, MINDUTY) in order to avoid unreliable or erroneous operations and the like during normal operations. However, in the present embodiment, it is now possible to reduce output power in an overloaded state without being subjected to a limitation on MINDUTY by setting a minimum on-duty during normal operations to a level at which erroneous operations can be avoided (in this case, MINDUTY) but, at the same time, enabling on-duty to drop to or below this value (MINDUTY) during an overloaded state. In addition, setting the on-duty to or below MINDUTY does not pose any problems whatsoever since an overload is an abnormal state and the occurrence of a certain degree of unreliable or erroneous operations will not be problematic as long as an excessive output current and the like can be avoided.

Furthermore, by enabling the on-duty during an overload to be set to or below MINDUTY as described above, it is now possible to sufficiently lower energy supplied to the output and to prevent an increase in an output current during an overload.

### Seventh Embodiment

An energy converting apparatus, and a semiconductor device and a switching control method used therein according to a seventh embodiment of the present invention will now be described.

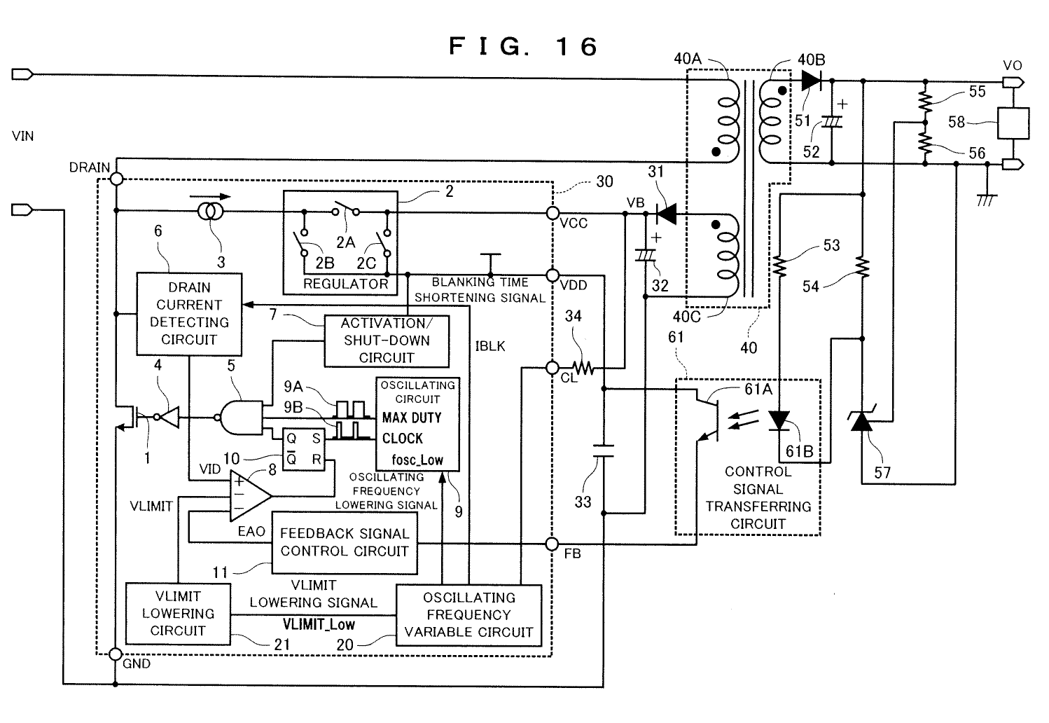

FIG. 16 is a block diagram showing a configuration example of a switching power supply that is the energy converting apparatus according to the seventh embodiment.

In the switching power supply shown in FIG. 16, an oscillating frequency variable circuit 20 is connected to a CL terminal. The oscillating frequency variable circuit 20 is connected to an oscillating circuit 9 and outputs, to the oscillating circuit 9, an oscillating frequency lowering signal fosc_Low that lowers an oscillating frequency as a CL terminal current ICL decreases. In addition, the oscillating frequency variable circuit 20 is connected to a VLIMIT lowering circuit 21 and a drain current detecting circuit 6, and when ICL drops, the oscillating frequency variable circuit 20 outputs a VLIMIT lowering signal VLIMIT_Low to the VLIMIT lowering circuit 21 and a blanking time shortening signal IBLK to the drain current detecting circuit 6.

When VLIMIT_Low is inputted, the VLIMIT lowering circuit 21 lowers VLIMIT and outputs the lowered VLIMIT to a comparator 8. Other configurations are similar to the first embodiment and a description thereof will be omitted.

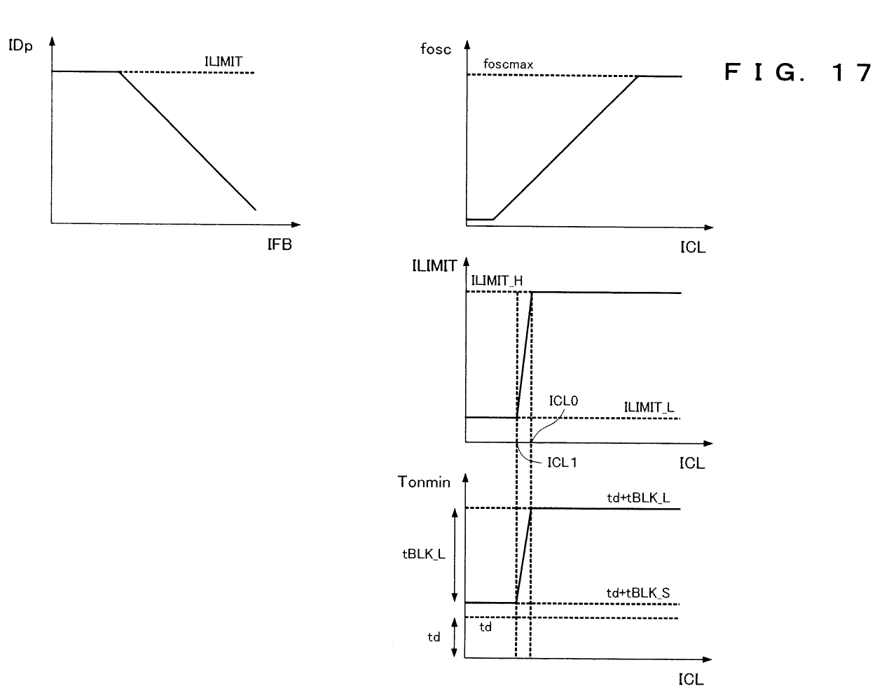

FIG. 17 is a diagram showing the relationships between signals inputted to terminals of a semiconductor device 30 and operational parameters of a switching element 1 according to the present embodiment. As is apparent from the diagram, the semiconductor device 30 according to the present embodiment is provided with characteristics in which an oscillating frequency fosc starts dropping as ICL drops, and as ICL further drops to ICL=ICL0, ILIMIT and a minimum on-time Tonmin also drop.

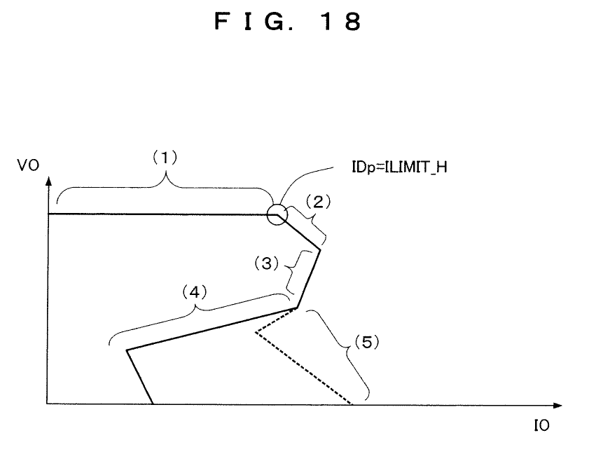

FIG. 18 shows a VO-IO characteristic diagram of the present switching power supply. Now, during an overload, as IDp rises to ILIMIT_H and an output voltage VO drops (characteristic (2)), an auxiliary winding voltage VB and ICL start to drop and, eventually, the oscillating frequency fosc starts to drop. As a result, output power is reduced and is prevented from increasing (characteristic (3)). Furthermore, as VO, VB, and ICL drop and ICL=ICL0 is reached, since ILIMIT drops and output power is significantly reduced, an output current IO is reduced (characteristic (4)).

A characteristic (5) indicated by the dotted line in FIG. 18 is a VO-IO characteristic in the case where the semiconductor device 30 is not provided with, for example, a function of reducing a blanking time tBLK. However, since a long minimum on-time prevents IDp from dropping even when ILIMIT is lowered by the VLIMIT variable circuit, an increase in output current cannot be prevented.

In contrast, when a function of reducing a blanking time tBLK is provided as is the case of the switching power supply according to the present embodiment, since IDp can be lowered regardless of the minimum on-time, an increase in output current can be sufficiently prevented as indicated by characteristic (4).

### Eighth Embodiment

An energy converting apparatus, and a semiconductor device and a switching control method used therein according to an eighth embodiment of the present invention will now be described.

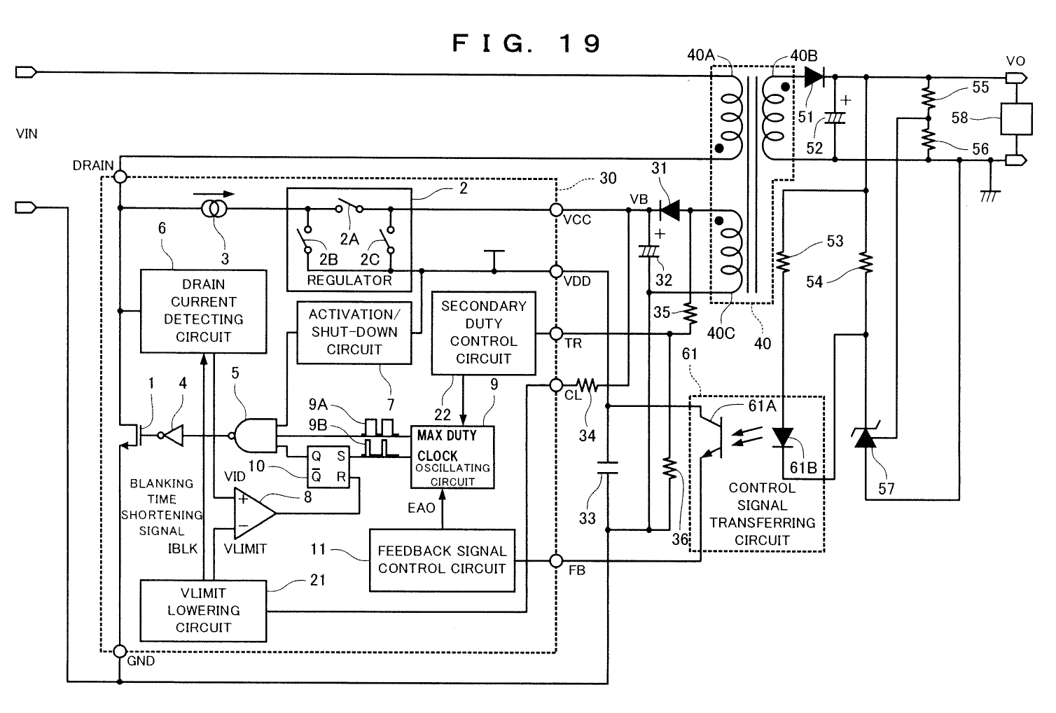

FIG. 19 is a block diagram showing a configuration example of a switching power supply that is the energy converting apparatus according to the eighth embodiment.

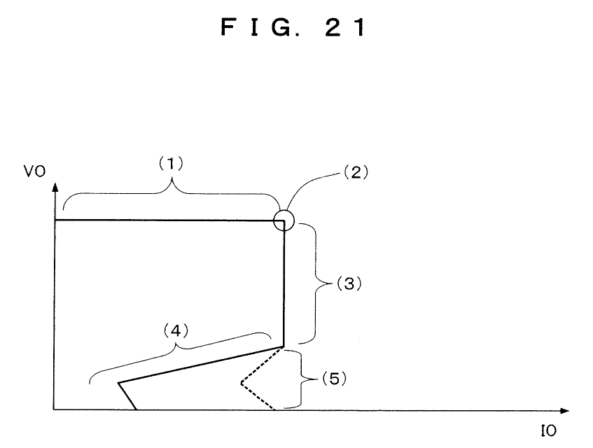

In the switching power supply shown in FIG. 19, a constant voltage characteristic is realized by frequency control in which an oscillating frequency is varied depending on a load state, while a constant current characteristic is realized by constantly controlling a secondary-side on-duty that is the proportion of a period during which a current flows through a secondary-side rectifying diode 51 to an oscillating period. Accordingly, constant voltage and constant current characteristics as shown in FIG. 21 can be realized.

In the power supply, a feedback signal control circuit 11 is connected to an oscillating circuit 9 and varies the oscillating frequency of the oscillating circuit 9 depending on a feedback terminal current IFB of the feedback signal control circuit 11. A TR terminal is provided in a semiconductor device 30, whereby a voltage waveform that is a constant multiple of an auxiliary winding voltage is detected through the TR terminal by resistors 35 and 36 connected to an auxiliary winding 40C. A secondary DUTY control circuit 22 connected to the TR terminal detects a timing at which a TR terminal voltage changes from positive to negative in a state where a switching element 1 is turned off, and outputs a relevant control signal to the oscillating circuit 9.

The oscillating circuit 9 is provided with: a function of varying a rising timing of a CLOCK signal according to an output signal EAO of the feedback signal control circuit 11; a function of varying a rising timing of a CLOCK signal so that a secondary-side on-duty becomes constant due to an output signal of the secondary DUTY control circuit 22; and a function of selecting whichever is later of the two CLOCK signal rising timings.

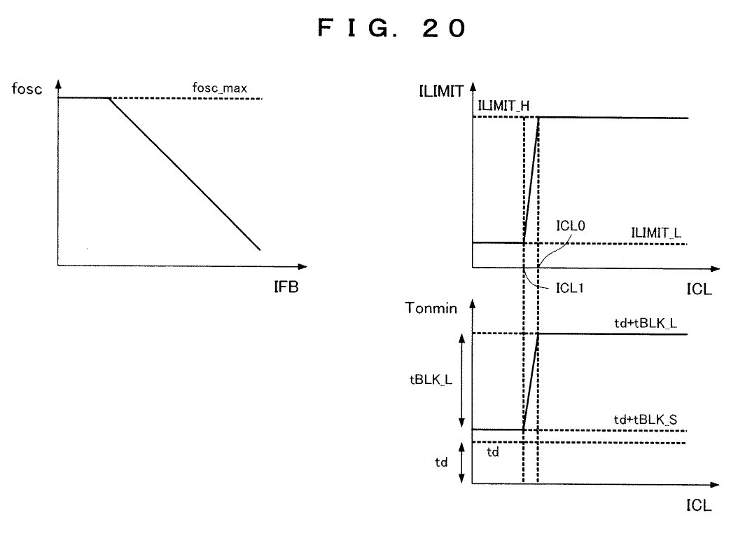

In addition, a VLIMIT lowering circuit 21 connected to a CL terminal is connected to a comparator 8 and a drain current detecting circuit 6. When a CL terminal current ICL drops to or below a predetermined value, the VLIMIT lowering circuit 21 lowers VLIMIT and ultimately causes ILIMIT to be lowered, and outputs a blanking time shortening signal IBLK to the drain current detecting circuit 6 to cause a blanking time tBLK to be shortened. In the VLIMIT lowering circuit, the turn-off timing of the switching element 1 is determined as an output VID of the drain current detecting circuit 6 becomes equal to or greater than VLIMIT and a reset signal is outputted from the comparator 8 to a flipflop 10. Relationships between signals inputted to the terminals of the semiconductor device 30 configured as described above and operational parameters of the same are shown in FIG. 20.

In the oscillating circuit 9, since the rising of the CLOCK signal determines the turn-on timing of the switching element 1, control is performed through the aforementioned functions by selecting whichever is lower of the oscillating frequency of the switching element 1 determined by the feedback signal control circuit 11 and an oscillating frequency determined by the secondary DUTY control circuit 22. In other words, a constant current operation commences during a constant voltage operation when an oscillating frequency rises to a value determined by secondary on-duty constant control.

Due to the operations described above, the present power supply is capable of realizing oscillating frequency control according to variances in IFB in area (1) in FIG. 21 representing constant voltage characteristics and realizing an operation that causes the secondary-side on-duty to become constant in area (3) representing constant current characteristics. A switchover point (2) therebetween is a point where the oscillating frequencies each determined by the control become equal to each other. When ICL is equal to or greater than ICL0 as shown in FIG. 20, VLIMIT is constant. Therefore, a peak value IDp of a switching current pulse does not vary in areas (1), (2), and (3) in FIG. 21.

Now, when an output voltage VO drops and ICL drops to ICL0 due to the constant current control represented by (3) in FIG. 21, ILIMIT and a minimum on-time Tonmin drop, and, as represented by (4) in FIG. 21, overload protection is realized in which an output current IO drops.

While the dotted line in FIG. 21 represents an example of VO-IO characteristics in the case where, for example, a function of reducing a minimum on-time is provided, as described above, since a long minimum on-time prevents IDp from dropping, the output current IO cannot be sufficiently lowered.

In a power supply for which such a constant current characteristic is required, it is often required that the output current IO during an overload protection be sufficiently reduced, thereby making the constant current characteristic a disadvantage. However, when a function of reducing a minimum on-time is provided as is the case with the present embodiment, this disadvantage can be resolved.

As described above, according to the first to fourth and sixth to eighth embodiments, in a power supply provided with an overload protective function that suppresses the peak value of a current waveform flowing through the switching element 1 during an overload, by shortening a minimum on-time in an overloaded state in comparison to a normal operation state that is not an overloaded state, the power supply can operate in a normal state without erroneous operations, and in an overloaded state, the peak value of a switching current pulse can be lowered without being restricted by the minimum on-time, thereby enabling prevention of an increase in an output current from becoming a disadvantage.

In addition, in a power supply that lowers an oscillating frequency during an overload, since a current flowing through the switching element 1 and a current value flowing through a magnetic part such as a transformer can be reduced even in the case where the oscillating frequency drops to an audible range, a noise of the magnetic part can be reduced.

Furthermore, according to the first, second, and fourth embodiments described above, in a power supply that activates a first overload protective function of detecting that an output voltage has dropped below a first threshold during an overload and lowering the peak value of a switching current pulse to reduce the output voltage, and that further reduces the output voltage to prevent an output current from becoming excessive through a second overload protective function of detecting that an output voltage has dropped below a second threshold that is lower than the first threshold and, for example, reducing the number of switchings of the switching element 1 per unit time, by reducing a minimum on-time in a state where the output voltage is higher than the second threshold, it is possible to avoid a situation where a failure of the switching current peak to drop prevents the output voltage from dropping to the second threshold and disables activation of the second overload protective function.

Moreover, according to the fifth embodiment described above, by providing a function of reducing a minimum on-time when an oscillation must occur in a state of low output voltage during an overload, it is possible to prevent a switching current from becoming excessive during the minimum on-time and the switching element 1 from being destroyed.

In addition, the switching element 1 and the control circuit can be provided in the same semiconductor to readily enable unification. Therefore, by providing primary circuit components in a single semiconductor, the number of components making up circuits can be reduced. Thus, as a power supply, downsizing, lightening, and even cost reduction can be readily achieved.

In the respective embodiments described above, while detection of an overloaded state is executed by detecting a drop in output voltage VO, a rise of the peak value of a switching current pulse to a predetermined value, or a rise of an oscillating frequency to a predetermined value, any method may be employed as long as an overloaded state can be detected.

In addition, in the first, second, and fourth embodiments described above, while detection of a drop in output voltage VO is executed by detecting variances in the auxiliary winding voltage VB that outputs a voltage proportional to the output voltage VO, any method may be employed as long as a drop in output voltage VO can be detected.

Furthermore, as shown in the respective embodiments described above, it is essential for the present invention that output power is suppressed by maintaining operational stability through a minimum on-time setting during normal operations that are not an overloaded state, and enabling switching operations of the switching element 1 at an on-time equal to or below the minimum on-time during an overloaded state. The minimum on-time may be: set by a delay period or a blanking time of overcurrent protection; set as the minimum on-duty of on-duty control; or set using any other technique as long as the minimum on-time is set during normal operations, in which case such a technique shall also be included in the present invention.

Moreover, in the first to fifth, seventh, and eighth embodiments described above, while minimum on-time control is executed by controlling a blanking time that is the dead time of switching current detection, any other method may be employed as long as the minimum on-time can be controlled.

While the respective embodiments presented above have been described using a primary-secondary insulation type flyback switching power supply or a non-insulated flyback switching power supply, the present technique is not affected by the configuration of the power supply. For example, configurations including a chopper power supply that uses a choke coil can be adopted.

In addition, while the respective embodiments presented above have been described primarily using PWM control as the control method of the switching element 1, the present invention is not affected by the control method, and any control method may be used including frequency-modulating PFM, burst control that controls the number of oscillations, control by a ringing choke converter, and a combination of these controls.

Furthermore, in the respective embodiments described above, while an overload protective function is realized by limiting output power using a method of lowering the peak value of a switching current pulse, a method of lowering an oscillating frequency, or a method of reducing the number of oscillations of the switching element 1 through an intermittent oscillation, any method may be used.

While a control circuit portion of the switching element 1 is the semiconductor device 30 in the respective embodiments described above, it is obvious that a configuration in which this portion is not formed on a semiconductor substrate and a discrete part is used instead, does not influence the effects of the present invention.

Moreover, while the respective embodiments presented above are described using an example where a transformer is used as an energy transferring element that converts and transfers energy from an input side to an output side, it is obvious that other energy transferring elements can be used as long as the same functions can be performed.

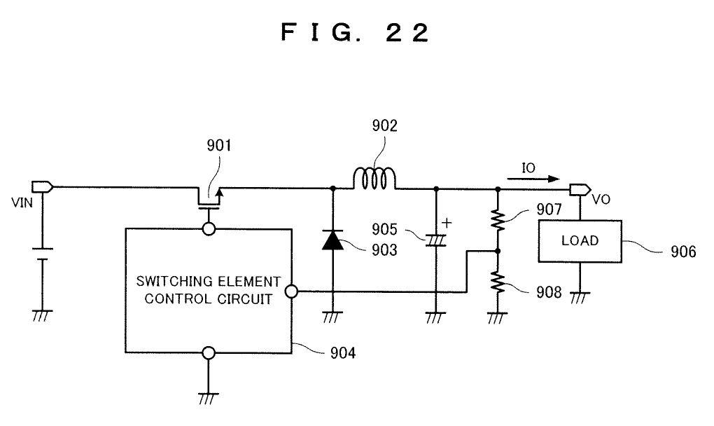

For example, the chopper power supply shown in FIG. 22 represents a configuration example of a case where a coil 902 is used as the energy transferring element. Even in such a chopper switching power supply, by providing a switching element control circuit 904 that controls a switching element 901 with functions such as described in the respective embodiments presented above, similar effects can be achieved.

Moreover, while the energy converting apparatuses according to the respective embodiments presented above are described primarily through a case where the present invention is used for a switching power supply, the present invention may be used for an energy converting apparatus other than a switching power supply as long as the apparatus converts power of a given form to power of a specific form that requires a load.

What is claimed is:

1. An energy converting apparatus for converting inputted energy of a certain form into energy of a specific form and outputs the converted energy, the energy converting apparatus comprising:
an input unit to which input energy is inputted from an outside;
an output unit from which output energy is outputted to the outside;
a switch having an input terminal, an output terminal and a control terminal;
a control circuit for controlling on/off of the switch, the control circuit being connected to the switch;
an energy transferring element to which one of the input terminal and the output terminal of the switch is connected;
a rectifying/smoothing unit for transferring energy to the output unit, the rectifying/smoothing unit being connected to the energy transferring element;
an output state detecting circuit for detecting a state as represented by a voltage or a current of the output unit; and
a load state detecting circuit, different from the output state detecting circuit, for detecting a state of a load connected to the output unit, wherein
the control circuit includes:
an on/off determining circuit for controlling the on/off of the switch in response to an output signal of the output state detecting circuit;
a circuit for determining a fixed minimum value of an on-period of the switch which is not affected by the output signal of the output state detecting circuit; and
a circuit into which an output signal of the load state detecting circuit is inputted and which varies a minimum value of the on-period of the switch in response to the signal,
the energy converting apparatus being arranged so that when the load state is detected to be abnormal, the minimum value of the on-period of the switch is shortened in comparison to a case where the load state is normal.

2. The energy converting apparatus according to claim 1, wherein
the load state detecting circuit is an output voltage detecting circuit for detecting a voltage value of the output unit,
the control circuit includes:
a circuit for determining a maximum value of energy supplied to the output unit; and
a circuit into which an output signal of the output voltage detecting circuit is inputted and which judges the load state based on a voltage value of the output unit, further wherein
when the load state is detected to be abnormal due to a drop of the voltage value of the output unit to a first threshold, the minimum value of the on-period of the switch is shortened in comparison to the case where the load state is normal.

3. The energy converting apparatus according to claim 2, wherein
the circuit for determining the maximum value of energy to be supplied to the output unit includes:
a circuit for detecting a current value flowing through the switch; and
a circuit for determining a maximum value of a current flowing through the switch.

4. The energy converting apparatus according to claim 3, wherein
the control circuit includes:
a circuit which realizes a first overload protective function of reducing the energy supplied to the output unit when the voltage value of the output unit drops to a second threshold.

5. The energy converting apparatus according to claim 4, wherein
as the first overload protective function,
the maximum value of the current flowing through the switch is lowered to reduce the energy supplied to the output unit.

6. The energy converting apparatus according to claim 5, wherein
as the first overload protective function,
when the voltage value of the output unit is lower than the second threshold, the more the voltage value of the output unit drops, the more the maximum value of the current flowing through the switch is lowered.

7. The energy converting apparatus according to claim 1, wherein
the control circuit includes:
a circuit for detecting a secondary-side on-duty which is a ratio of a period of time during which a current flows through the rectifying/smoothing unit and an oscillating period of the switch;
a circuit for detecting a voltage value of the output unit, the circuit being provided separate from the output state detecting circuit; and
a circuit for judging the load state based on the voltage value of the output unit, further wherein
the control circuit varies an oscillating frequency of the switch so that the secondary-side on-duty becomes constant, and
when the load state is detected to be abnormal due to a drop of the voltage value of the output unit to a first threshold, the control circuit shortens the minimum value of the on-period of the switch in comparison to the case where the load state is normal.

8. The energy converting apparatus according to claim 4, wherein
as the first overload protective function,
the number of switchings of the switch performed per unit time is reduced.

9. The energy converting apparatus according to claim 8, wherein
as the first overload protective function,
when the voltage value of the output unit is lower than the second threshold, the more the voltage value of the output unit drops, the more the number of switchings of the switch performed per unit time is reduced.

10. The energy converting apparatus according to claim 9, wherein
as the first overload protective function,
the number of switchings of the switch performed is reduced by lowering an oscillating frequency of the switch.

11. The energy converting apparatus according to claim 9, wherein
as the first overload protective function,
the number of switchings of the switch performed is reduced by providing a period in which the switch is unswitchable.

12. The energy converting apparatus according to claim 4, wherein
the control circuit includes
a circuit which realizes a second overload protective function of reducing the energy supplied to the output unit when the voltage value of the output unit drops to a third threshold that is lower than the second threshold, the second overload protective function being different from the first overload protective function.

13. The energy converting apparatus according to claim 12, wherein
the control circuit sets
the first threshold higher than the third threshold.

14. The energy converting apparatus according to claim 12, wherein
the control circuit sets
lowering of the maximum value of the current flowing through the switch as the first overload protective function and lowering of an oscillating frequency of the switch as the second overload protective function.

15. The energy converting apparatus according to claim 12, wherein
the control circuit sets
lowering of the maximum value of the current flowing through the switch as the first overload protective function and providing of a period in which the switch is unswitchable as the second overload protective function.

16. The energy converting apparatus according to claim 12, wherein
the control circuit sets
lowering of an oscillating frequency of the switch as the first overload protective function and lowering of the maximum value of the current flowing through the switch as the second overload protective function.

17. The energy converting apparatus according to claim 2, wherein
the control circuit includes:
a circuit such that the more the voltage value of the output unit drops, the more the circuit reduces the minimum value of the on-period of the switch.

18. The energy converting apparatus according to claim 2, wherein
the energy transferring element is a transformer including:
a first winding connected to the input unit and to the switch;
a second winding connected to the rectifying/smoothing unit; and
a third winding connected to the control circuit, and
the load state detecting circuit includes:
a circuit for detecting a voltage value of the third winding, and
detects the voltage value of the output unit based on the detected voltage value of the third winding.

19. The energy converting apparatus according to claim 1, wherein
the load state detecting circuit is a circuit for detecting a current value flowing through the switch,
the control circuit includes:
a circuit for detecting the current value flowing through the switch, and
detects that the load state has become abnormal when the current value flowing through the switch reaches or exceeds a threshold to reduce the minimum value of the on-period of the switch.

20. The energy converting apparatus according to claim 1, wherein
the load state detecting circuit is a circuit for detecting an oscillating frequency of the switch, and
the control circuit detects that the load state has become abnormal when an oscillating frequency of the switch reaches or exceeds a threshold to reduce the minimum value of the on-period of the switch.

21. The energy converting apparatus according to claim 1, wherein
the control circuit includes
a function in which the on/off determining circuit varies an on-duty of the switch depending on the output signal of the output state detecting circuit, and
the minimum value of the on-period of the switch is determined by a minimum value of an on-duty of the switch.

22. The energy converting apparatus according to claim 1, wherein
the control circuit includes:
a circuit for detecting a current value flowing through the switch;
a circuit for determining a maximum value of a current flowing through the switch;
a circuit for detecting the current value flowing through the switch after the switch is turned on or a circuit for providing a blanking time in which the circuit for determining the maximum value of the current flowing through the switch is not activated; and
a circuit for varying the blanking time,
the control circuit setting a portion of or all of the minimum value of the on-period of the switch as the blanking time.

23. The energy converting apparatus according to claim 22, wherein
the control circuit reduces the minimum value of the on-period of the switch by shortening the blanking time.

24. A semiconductor device to be used in the energy converting apparatus according to claim 1, wherein
a portion of or all of the control circuit is formed on a single semiconductor substrate.

25. A semiconductor device to be used in the energy converting apparatus according to claim 1, wherein
a portion of or all of the control circuit as well as the switch are formed on a same semiconductor substrate.

26. A switch control method that executes, in the energy converting apparatus according to claim 1, the steps of:
determining the minimum value of the on-period of the switch;
varying the minimum value of the on-period of the switch; and
detecting the load state, when controlling the on/off of the switch, wherein
when the load state is detected to be abnormal, the minimum value of the on-period of the switch is shortened in comparison to a case where the load state is normal.
